(19) United States
(12) Patent Application Publication
(10) Pub. No.: US 2011/0198958 A1
(43) Pub. Date: Aug. 18, 2011

(54) LINEAR PERMANENT MAGNET MOTOR

(75) Inventor: Kenneth C. Kozeka, Fairview, TN (US)

(73) Assignee: Nescor Power, LLC, North Bergen, NJ (US)

(21) Appl. No.: 12/666,125

(22) PCT Filed: May 30, 2008
(86) PCT No.: PCT/US08/65351

§ 371 Date: Apr. 12, 2011

Related U.S. Application Data
(60) Provisional application No. 60/946,135, filed on Jun. 25, 2007.

(51) Int. Cl. H02K 21/00; H02N 11/00

(52) U.S. Cl. 310/152; 74/DIG. 9

(57) ABSTRACT

A method of generating energy and a permanent magnet motor are disclosed. A method of generating energy is disclosed, comprising the steps of providing a first permanent magnet in a first initial location and a second permanent magnet in a second initial location, where the first and second magnets are positioned such that their poles have approximately the same relative orientation, moving the first and second magnets towards each other relatively by moving either or both the first magnet and the second magnet substantially along a first axis that is approximately perpendicular to the orientation of their poles, separating the first and second magnets by moving either or both the first magnet and the second magnet substantially along a second axis that is approximately parallel to the orientation of their poles, and returning the first and second magnets to their respective first and second initial locations.

### CROSS-REFERENCE TO RELATED APPLICATIONS

This application claims benefit of U.S. provisional application No. 60/946,135 filed Jun. 25, 2007, the disclosure of which is incorporated by reference as if set forth in its entirety herein.

### FIELD OF THE INVENTION

The present invention relates to a method and apparatus for generating energy, particularly a method and apparatus for generating energy from the cyclic motion of permanent magnets.

### BACKGROUND OF THE INVENTION

Permanent magnets having two or more poles generate unevenly distributed magnetic fields and therefore have uneven magnetic energy spatial distributions. For example, the distribution of the attractive or repulsive forces generated between a pair of permanent magnets by moving the magnets perpendicular to the common orientation of their poles (horizontally) is different than the distribution of the attractive or repulsive forces generated by moving the magnets parallel to the common orientation of their poles (vertically).

Currently available permanent magnet motors typically include magnets positioned in a circle and attached to a rotating shaft, and the motors typically incorporate circular motion pathways for the permanent magnets. See, e.g., U.S. Pat. No. 5,594,289, for an example of a magnet motor including a rotating shaft. These circular-oriented motor designs have not been demonstrated to produce a net energy yield. There is no net energy yield because the work generated when the included permanent magnets either come together or push apart for a power generation cycle is essentially equal to the work needed to return the system to the starting position for the next cycle. As a result, previous permanent magnet motors typically have required an external energy source in order to operate. Currently, there is no permanent magnet motor that operates without an external energy source, i.e., solely on the forces generated by the permanent magnets.

### SUMMARY OF THE INVENTION

A method of generating energy and a permanent magnet motor are disclosed, for generating energy from the cyclic motion of permanent magnets. A method of generating energy is disclosed, comprising the steps of providing a first permanent magnet in a first initial location and a second permanent magnet in a second initial location, where the first and second magnets are positioned such that their poles have approximately the same relative orientation, moving the first and second magnets towards each other relatively by moving either or both the first magnet and the second magnet substantially along a first axis that is approximately perpendicular to the orientation of their poles (horizontal direction), separating the first and second magnets by moving either or both the first magnet and the second magnet substantially along a second axis that is approximately parallel to the orientation of their poles (vertical direction), and returning the first and second magnets to their respective first and second initial locations.

A permanent magnet motor is disclosed, comprising first and second magnets, a non-circular pulley or gear including a variable-leverage arm profile, coupled to the first magnet, and an energy-storage device, coupled to the non-circular pulley or gear, wherein the freedom of motion of the first and second magnets is constrained such that the magnets are only capable of moving towards each other or separating by moving either or both the first magnet and the second magnet substantially along a first axis or a second axis, wherein the first axis is approximately perpendicular to the orientation of their poles (horizontal axis), and wherein the second axis is approximately parallel to the orientation of their poles (vertical axis).

The disclosed methods of generating energy and the permanent magnet motors may also include using attractive magnetic forces to assist the motion of the first magnet and the second magnet towards each other, providing a magnetic shield around a portion of either or both the first magnet and the second magnet, storing a part of the kinetic energy produced when the first and second magnets are moved towards each other, and using a spring to store part of the energy produced. A first pulley or gear and/or second pulley or gear may be provided that may be non-circular and include a variable-leverage arm profile. The variable-leverage arm profile of the first pulley or gear and/or second pulley or gear may be correlated to the shape of a curve of the magnetic force experienced by either the first or second magnet when the first and second magnets are moved towards each other. A portion of the stored energy may be transferred to an external device, such as an electric generator or a flywheel.

### BRIEF DESCRIPTION OF THE DRAWINGS

FIG. 1A is a diagrammatic view of the kinetic energy-generating path taken by a first moveable permanent magnet as it is drawn by magnetic attraction forces towards a second stationary magnet, illustrating a first embodiment of the invention.

FIG. 1B is a diagrammatic view of the energy-consuming path taken by the first moveable permanent magnet as it is drawn away from a second stationary magnet by a stored-energy force, in the embodiment depicted in FIG. 1A.

FIG. 1C is a quantitative comparison of the magnetic force (in pounds) acting on the first magnet, at 1/32″ intervals, as it moves along the paths depicted in FIGS. 1A and 1B.

FIGS. 2A, 2B, and 2C are diagrammatic views of three positions within a single energy-generating cycle of an exemplary linear permanent magnet motor, comprising two moveable permanent magnets and an energy-storage device including a non-circular pulley including a variable-leverage arm profile coupled to a spring, illustrating a second embodiment.

FIG. 2D is a qualitative comparison of the magnetic force acting on the first magnet as it moves along the path depicted in FIGS. 2A and 2B, and the force required to load or stretch the energy-storage device depicted in FIGS. 2A and 2B as the first magnet moves.

FIGS. 2E and 2F are diagrammatic views of two rotational orientations of an exemplary non-circular first pulley 43a having a variable-leverage arm profile, in the embodiment depicted in FIGS. 2A-2C.

FIGS. 3A and 3B are diagrammatic views of the shape of the magnetic field and direction of field lines surrounding a stationary permanent magnet, with and without the use of magnetic shielding around a portion of the stationary permanent magnet, respectively, illustrating a third embodiment.

FIG. 4 is a diagrammatic view of an exemplary linear permanent magnet motor, comprising three pairs of moveable permanent magnets coupled to a single crankshaft, each magnet pair performing a different step of the energy-generation process at any given time, illustrating a fourth embodiment.

FIG. 5 is a diagrammatic view of an exemplary linear permanent magnet motor, comprising six pairs of permanent magnets attached to a single pair of moveable heads, coupled to a single crankshaft, each magnet pair performing the same step of the energy-generation process at any given time, illustrating a fifth embodiment.

FIG. 6 is a diagrammatic view of an exemplary linear permanent magnet motor, comprising two moveable permanent magnets and three stationary permanent magnets, illustrating a sixth embodiment.

FIGS. 7A and 7B are diagrammatic views of an exemplary linear permanent magnet motor, comprising three moveable permanent magnets, illustrating a seventh embodiment.

FIG. 8 is a diagrammatic view of an exemplary linear permanent magnet motor, comprising four moveable permanent magnets, illustrating an eighth embodiment.

### BRIEF DESCRIPTION OF THE APPENDICES

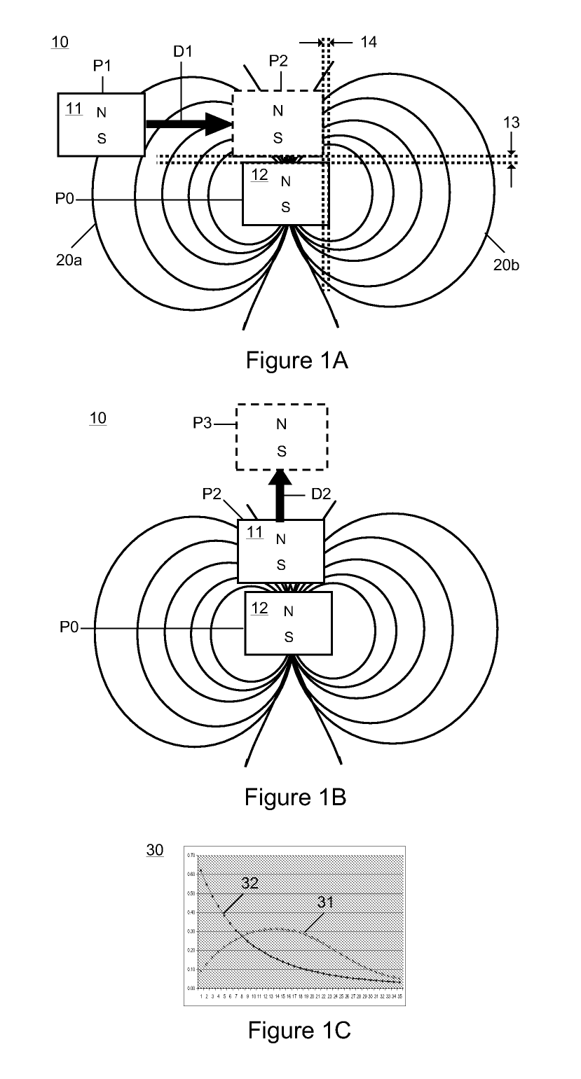

Appendix A-1 is a table and graph showing the raw data collected from three trials measuring the attractive magnetic force acting on the first magnet 11 (according to the first embodiment depicted in FIGS. 1A-1C) at 1/32″ intervals along a horizontal path taken by the first magnet 11, moving from the intermediate position P2 to the initial position P1.

Appendix A-2 is a table and graph showing the raw data collected from three trials measuring the attractive magnetic force acting on the first magnet 11 (according to the first embodiment depicted in FIGS. 1A-1C) at 1/32″ intervals along a vertical path taken by the first magnet 11, moving from the intermediate position P2 to the final position P3.

Appendix A-3 is a table and graphs showing the raw data collected from five sets of three trials each, measuring the attractive magnetic force acting on the first magnet 11 (according to the first embodiment depicted in FIGS. 1A-1C) at 1/32″ intervals along a horizontal path taken by the first magnet 11, moving from the intermediate position P2 to the initial position P1, using five different values of the gap spacing 13.

Appendix A-4 is a table and graphs showing the raw data collected from five sets of three trials each, measuring the attractive magnetic force acting on the first magnet 11 (according to the first embodiment depicted in FIGS. 1A-1C) at 1/32″ intervals along a vertical path taken by the first magnet 11, moving from the intermediate position P2 to the final position P3, using five different values of the stagger spacing 14.

Appendix A-5 is a table and graph showing the raw data collected from 25 trials, measuring the total work (energy) expended to move the first magnet 11 (according to the first embodiment depicted in FIGS. 1A-1C) along a horizontal path taken by the first magnet 11, moving from the intermediate position P2 to the initial position P1 (opposite the direction D1), using five different values of the gap spacing 13, and along a vertical path taken by the first magnet 11, moving from the intermediate position P2 to the final position P3 (in the direction D2), using five different values of the stagger spacing 14.

### DETAILED DESCRIPTION OF ILLUSTRATIVE EMBODIMENTS

Permanent magnets have uneven magnetic energy spatial distributions. Therefore, the work or mechanical energy generated by moving a pair of permanent magnets together along a first path (e.g., horizontally) may exceed the mechanical energy required to separate the same pair of permanent magnets along a second, “weaker” path (e.g., vertically). A completed permanent magnet motion cycle using the aforementioned first path and second path may result in a net production of mechanical energy that may transferred to an external device, e.g., an electric generator or flywheel.

FIGS. 1A and 1B depict three positions of the kinetic energy-generating path taken by a first moveable permanent magnet as it is drawn by magnetic attraction forces towards a second stationary magnet and then drawn away from the second stationary magnet by the use of a stored-energy force, illustrating a first embodiment of a permanent magnet motor. Referring to FIG. 1A to illustrate a preferred structure and function of the present invention, a permanent magnet motor 10 includes a first magnet 11 and a second magnet 12. The second magnet 12 includes magnetic field portions 20a and 20b.

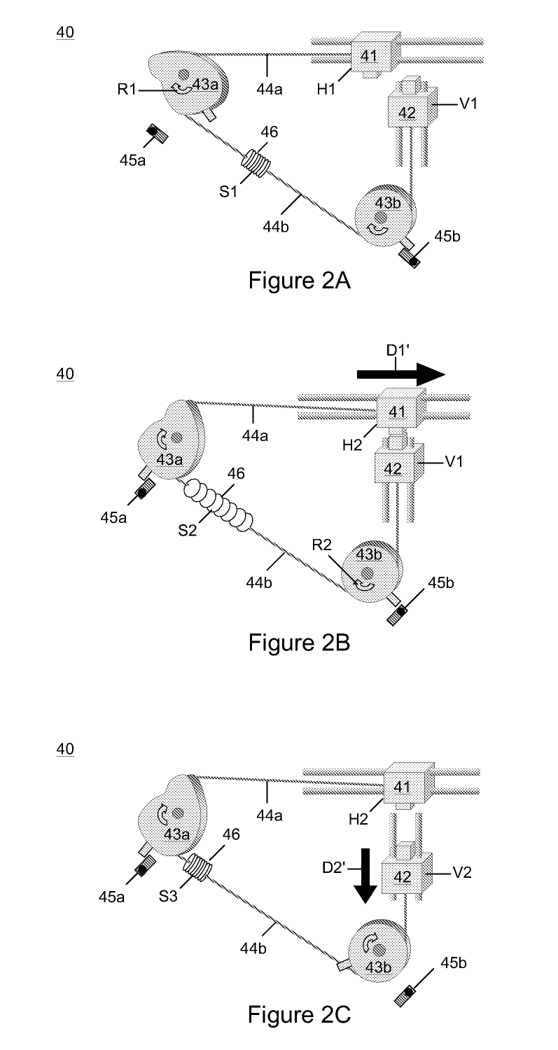

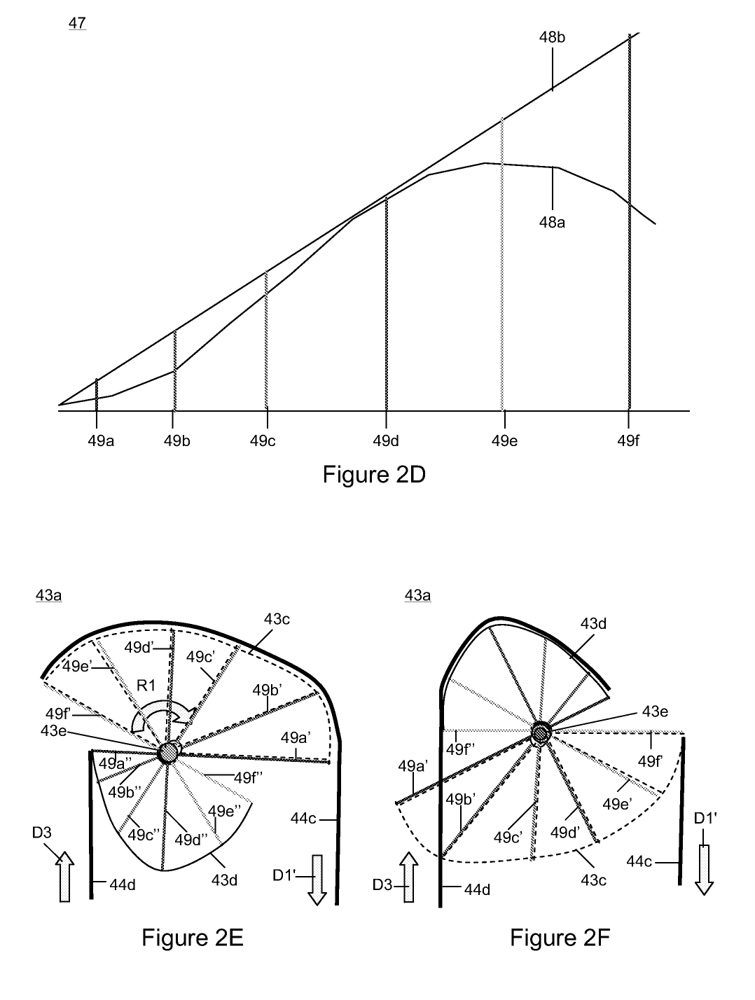

In a first embodiment of the permanent magnet motor 10, two permanent magnets 11 and 12 are used to generate mechanical energy, which preferably is transferred to an external device (not shown), such as an electric generator. The energy-generation process depicted in FIGS. 1A and 1B has an initial state, in which the first magnet 11 is located at an initial position P1 and the second magnet 12 is located at a position P0. The position P0 is a fixed location of the magnet 12, in the embodiment shown in FIG. 1A, but the magnet 12 may be moveable in alternative embodiments (e.g., the embodiment shown in FIGS. 2A, 2B, and 2C).

While the motor 10 is in the initial state, as well as throughout the energy-generation process of motor 10, the poles of the magnets 11 and 12 preferably have approximately the same relative orientation, such that lines drawn from the north to south pole (pole axes) of each magnet 11 and 12 are approximately parallel. In some embodiments, the pole axes of the magnets 11 and 12 may be arranged such that they are not parallel, but the inventor theorizes that a parallel orientation of the pole axes of the magnets 11 and 12 may produce a higher energy net yield for the motor 10. In some embodiments, the relative orientation of the pole axes of magnets 11 and 12 may change during the energy-generation process. For example, the pole axes of magnets 11 and 12 may be parallel while motor 10 is in the initial state, but the pole axes of magnets 11 and 12 may not be parallel at intermediate steps during the energy-generation process.

While the motor 10 is in the initial state, as well as throughout the energy-generation process of motor 10, the poles of the magnets 11 and 12 preferably are oriented such that the attractive magnetic force between the magnets 11 and 12 is the dominant magnetic force acting on the magnets 11 and 12. For example, in an exemplary embodiment, shown in FIG. 1A, the south pole of the first magnet 11 is the closest pole of the first magnet 11 to the north pole of the second magnet 12. In other embodiments (not shown), the repulsive magnetic force between the magnets 11 and 12 may be the dominant magnetic force acting on the magnets 11 and 12. In these alternative embodiments, the north-south pole orientation of the magnet 12, relative to the north-south pole orientation of the magnet 11, will be reversed.

In other embodiments (not shown), a combination of attractive and repulsive magnetic forces between the magnets 11 and 12 may be used during the power-generation process of the motor 10. For example, the magnets 11 and 12 may initially be oriented such that the attractive magnetic force dominates, causing the first magnet 11 to be drawn towards the second magnet 12. At some point during the energy-generation process, the first magnet 11 may be rotated relative to the second magnet 12, such that the repulsive magnetic force dominates, causing the first magnet 11 to be repelled away from the second magnet 12.

In an exemplary embodiment, the first magnet 11 and the second magnet 12 are permanent magnets made of neodymium (NdFeB), a material developed by Hitachi Metals. In other embodiments, magnets 11 and 12 may be made from other materials, including those that are widely understood among those skilled in the art. In an exemplary embodiment, the first magnet 11 and the second magnet 12 are approximately the same size, shape, and of the same magnetic field strength as each other. However, in other embodiments, the relative size, shape, and magnetic field strength of the first magnet 11 and the second magnet 12 may vary, depending on the particular desired energy-yield performance of motor 10.

In an exemplary embodiment, each of the first magnet 11 and the second magnet 12 are relatively flat in shape and have a rectangular cross-section, with the height (the dimensional axis parallel to a line going through the north and south poles of the magnet, i.e., the pole axis) of each magnet 11 and 12 being the shortest dimension, compared with the length and width (the dimensional axes perpendicular to the pole axis). Compared to a cube-shaped magnet (with equal length, width, and height), the magnetic field surrounding a relatively flat magnet of the same weight and material will be spatially-uneven to a greater degree, which the inventor theorizes may allow motor 10 to produce a greater net energy yield. Embodiments including relatively flat-shaped magnets 11 and 12 may produce a higher net yield percentage than embodiments with more cubic-shaped magnets. However, in some exemplary embodiments, cubic-shaped magnets 11 and 12 are used.

In an exemplary embodiment, the magnets 11 and 12 each define a cubic shape, measuring ¾″ in each dimension. In other embodiments, the magnets 11 and 12 may have different respective lengths and widths (e.g., having non-square cross-sections). In an exemplary embodiment, magnets 11 and 12 each define a relatively flat shape with a rectangular cross-section, measuring 4″×2″×′½″ (length×width×height) and weighing 17 ounces, with a maximum magnetic attraction force between them of 641 pounds. The size of the magnets 11 and 12 may vary, depending on the size of the machine for which they are designed to generate energy. For example, for smaller permanent magnet motors 10, the magnet size may range between ⅛″-12″×⅛″-12″× 1/16″-6″ (length×width×height).

The magnets 11 and 12 may have any rotational position (about their pole axes) relative to each other. In some embodiments, the magnets 11 and 12 may define non-rectangular cross-sections, for example, including circular, curvilinear, triangular, hexagonal, octagonal, or any other cross-section. The shape of the magnets 11 and 12 that are used in any particular motor 10 may be determined based on the desired size, shape, and desired net energy-yield and other performance characteristics of motor 10.

As shown in FIG. 1A, the magnetic field portions 20a and 20b of the second magnet 12 can be seen, and a portion of the magnetic field portion 20a envelops a portion of the first magnet 11. The first magnet 11 is initially placed at a position P1 that is close enough to the second magnet 12 such that the attractive magnetic force between the magnets 11 and 12 is strong enough (represented by the first magnet 11 being located at the position P1 within the magnetic field portion 20a of the second magnet 12) to overcome any inertia and/or friction forces preventing the first magnet 11 from beginning to move. This initial distance between the magnets 11 and 12 may vary, depending on the particular application and dimensions of the motor 10.

Once the attractive magnetic force between the magnets 11 and 12 overcomes the inertia force and begins to move the first magnet 11 towards the second magnet 12, the first magnet 11 travels in a direction D1 towards an intermediate position P2. As shown in FIG. 1A, the direction D1 is a first linear direction (horizontal direction) that is approximately perpendicular to the orientation of the poles (vertical direction) of the first magnet 11 and the second magnet 12. The motion of the first magnet 11 preferably may be constrained along the direction D1 by any mechanism, including those that are widely understood among those skilled in the art. For example, as shown in FIG. 2A, two guide rails may be used to constrain the motion of the first magnet 11, along a particular linear or nonlinear direction towards second magnet 12.

In the embodiment depicted in FIGS. 1A and 1B, the first magnet 11 travels in the direction D1 towards the stationary second magnet 12. In some embodiments, the second magnet 12 may travel in the direction opposite the direction D1 towards the first magnet 11. In other embodiments, the first magnet 11 and the second magnet 12 may both travel towards each other at the same time, the first magnet 11 traveling in the direction D1, and the second magnet 12 traveling in a direction opposite the direction D1.

In the exemplary embodiment shown in FIGS. 1A and 1B, the direction D1 is linear. In other embodiments, the direction D1 may be non-linear or curvilinear. The exact path that the first magnet 11 takes as it travels from the initial position P1 towards the intermediate position P2 may vary, based on the desired size, shape, and desired net energy-yield and other performance characteristics of motor 10.

In some embodiments, energy from an outside source (not shown), or a switch mechanism (e.g., a mechanical, electrical, or magnetic switch), or both, may be used to provide some or all of the energy required to overcome the inertia force to begin to move the first magnet 11 from the initial position P1 towards the intermediate position P2. In other embodiments (not shown), the first magnet 11 may still have some remaining momentum in the direction D1 from a previous energy-generation cycle that may be used to begin the motion of the first magnet 11 from the initial position P1 towards the intermediate position P2.

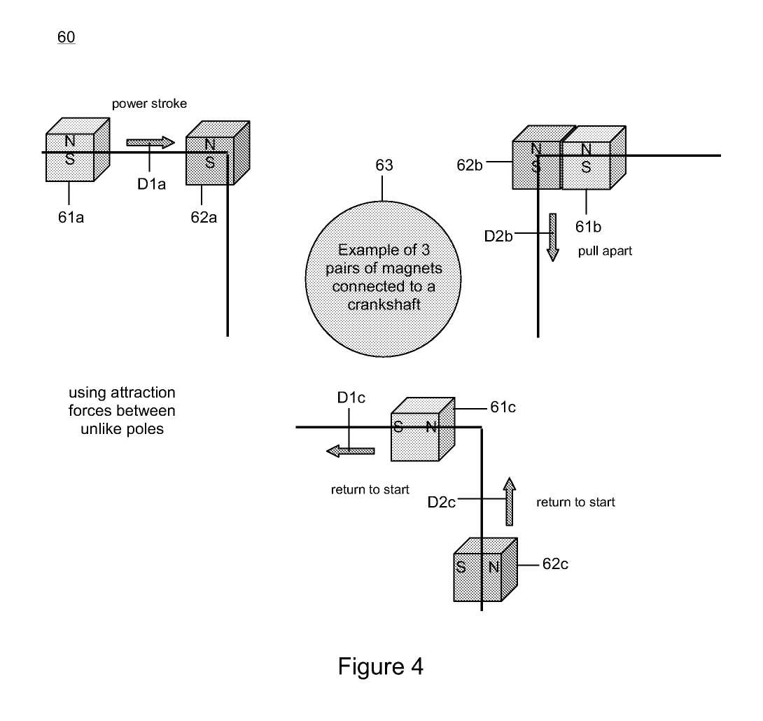

While the first magnet 11 moves from position P1 to position P2, towards the second magnet 12, the kinetic energy produced by the motion of the first magnet 11 may be transferred to an energy-storage device, as shown in FIG. 2A, which preferably stores substantially all of the kinetic energy produced by the motion of the first magnet. The energy-storage device preferably is a spring, as shown in FIG. 2A, but the energy-storage device may also be any other energy-storage device understood among those skilled in the art. In some embodiments, as shown in FIGS. 4 and 6 and discussed in the accompanying text, no energy-storage device may be needed. For example, as shown in FIGS. 4 and 6, an energy-storage device may not bee needed in embodiments where multiple magnet pairs are coupled together and each pair cycles through the energy-generation process out-of-phase with the other pairs.

When the first magnet 11 reaches the intermediate position P2, proximate the second magnet 12, the first magnet 11 and the second magnet 12 preferably are at the closest distance to each other that they reach during the operation of this embodiment of motor 10. As shown in FIG. 1A, the relative closest approach locations of the first magnet 11 at position P2 and the second magnet 12 at position P0 are determined by the gap spacing 13 (vertical distance between the magnets 11 and 12) and the stagger spacing 14 (horizontal distance between the pole axes of magnets 11 and 12).

The gap spacing 13 between the first magnet 11 and the second magnet 12 may be any distance, depending on the particular relative dimensions of the components of motor 10 and the particular desired net energy-production performance requirements of motor 10. Preferably, the gap spacing 13 is greater than zero, because a gap spacing 13 of zero may result in a very high required initial force to begin to separate the first magnet 11 and the second magnet 12 so the first magnet 11 can be returned to the initial position P1 for another cycle of motor 10 (there is an inverse relationship between the gap spacing 13 and the required initial force to begin to separate the magnets 11 and 12). The gap spacing 13 may be experimentally optimized for particular sizes and shapes of the first magnet 11 and the second magnet 12 and particular net energy-production targets, as shown in Appendices A-3 and A-5.

As shown in FIG. 1A, the stagger spacing 14 represents the closest distance between of the pole axes of the first magnet 11 and the second magnet 12 that is reached during the operation of motor 10. This stagger spacing 14 between the first magnet 11 and the second magnet 12 may be any distance, depending on the particular relative dimensions of the components of motor 10 and the particular desired net energy-production performance requirements of motor 10. Preferably, the stagger spacing 14 is greater than zero, because there is an inverse relationship between the stagger spacing 14 and the required initial force to begin to separate the magnets 11 and 12. Also, in some embodiments, there may not be enough momentum remaining in the magnet 11, as it reaches the end of its travel in direction D1, to allow the pole axes of the magnets 11 and 12 to become coincident without the use of an external energy source. The stagger spacing 14 may be experimentally optimized for particular sizes and shapes of the first magnet 11 and the second magnet 12 and particular net energy-production targets, as shown in Appendices A-4 and A-5.

As shown in FIG. 1A, the stagger spacing 14 may be calculated by measuring the horizontal distance between the far edges (farthest from the initial position P1 of the magnet 11) of the magnets 11 and 12, along the axis defined by the direction D1. In embodiments using magnets 11 and 12 that are approximately the same size, the aforementioned edge-based method of calculating the stagger spacing 14 may be a close approximation of the distance between of the pole axes of the first magnet 11 and the second magnet 12 (pole-based method). However, in embodiments in which the magnets 11 and 12 are not approximately the same size, the edge-based method and pole-based method of calculating the stagger spacing 14 may not yield the same result, so in these embodiments, the pole-based method should be used to calculate the stagger spacing 14.

As shown in FIG. 1B, after the first magnet 11 reaches position P2, proximate the second magnet 12, the first magnet 11 travels away from the second magnet 12 in a direction D2 towards a final position P3. The direction D2 is a second linear direction (vertical direction) that is approximately parallel to the pole axes of the first magnet 11 and the second magnet 12. The motion of the first magnet 11 may be constrained along the direction D2 by any mechanism, including those that are widely understood among those skilled in the art. For example, as shown in FIG. 2A, two guide rails may be used to constrain the motion of the first magnet 11, along a particular linear or nonlinear direction away from second magnet 12.

In the embodiment depicted in FIGS. 1A and 1B, the first magnet 11 travels in the direction D2 away from the stationary second magnet 12. In some embodiments, the second magnet 12 may travel in the direction opposite the direction D2 away from the first magnet 11. In other embodiments, the first magnet 11 and the second magnet 12 may both travel away from each other at the same time, the first magnet 11 traveling in the direction D2, and the second magnet 12 traveling in a direction opposite the direction D2.

In the exemplary embodiment shown in FIGS. 1A and 1B, the direction D2 is linear. In other embodiments, the direction D2 may be non-linear or curvilinear. The exact path that the first magnet 11 takes as it travels from the intermediate position P2 towards the final position P3 may vary, based on the desired size, shape, and desired net energy-yield and other performance characteristics of motor 10.

In this embodiment, the motion of the first magnet 11 from the intermediate position P2 to the final position P3 is counter to the magnetic attraction forces acting between the first magnet 11 and the second magnet 12. During the movement of the first magnet 11 from the intermediate position P2 to the final position P3, the magnetic attraction force between the first magnet 11 and the second magnet 12 is strongest when the magnets 11 and 12 are closest to each other, i.e., when the magnet 11 is in the intermediate position P2. Therefore, in this embodiment, a separation force must be exerted on the first magnet 11 to counter the magnetic attraction forces, while the first magnet 11 is in the intermediate position P2, to permit the beginning of the separation of the magnets 11 and 12. In this embodiment, there may be a required amount of force to overcome the inertia force in the direction D2 to allow the first magnet 11 to begin to move towards the final position P3.

While the first magnet 11 moves from the intermediate position P2 to the final position P3, the stagger spacing 14 between the pole axes of the first magnet 11 and the second magnet 12 preferably is maintained. However, in some embodiments, the direction D2 along which the first magnet 11 travels as it moves from position P2 to position P3 may be non-linear. In these embodiments, the stagger spacing 14 may be increased or decreased as the first magnet 11 travels towards the final position P3.

In some embodiments, a first portion of the energy stored in the aforementioned energy-storage device may be transferred back to the first magnet 11 to allow the first magnet 11 to move towards the final position P3, overcoming the inertia force and magnetic attraction force acting on it in the direction D2 (an energy-storage device is depicted, for example, as a spring in FIG. 2A). In other embodiments, energy from an outside source (not shown) may be used to provide some or all of the energy required to move the first magnet 11 towards the final position P3. In other embodiments (not shown), the first magnet 11 may still have some momentum in the direction D2, when the first magnet 11 is at the closest approach point to the second magnet 12, that may be used to begin the separation movement of the first magnet 11 towards the final position P3.

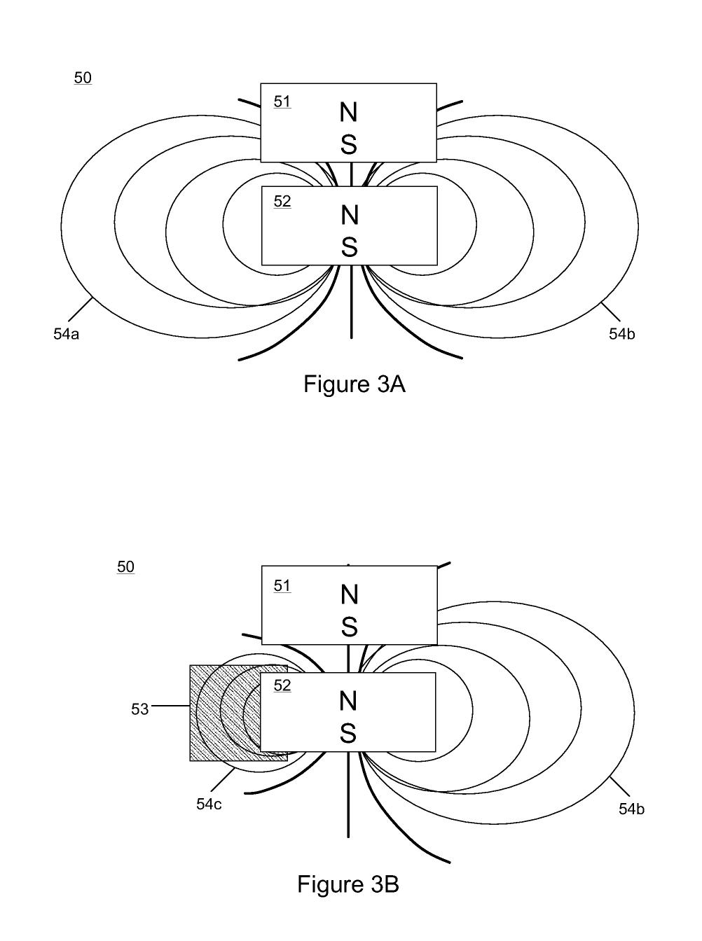

In some embodiments, a magnetic shield may be applied to a portion of the second magnet 12 and/or the first magnet 11 to alter the magnetic field of the second magnet 12 and/or the first magnet 11, thereby reducing the force and/or energy required to pull the first magnet 11 away from the second magnet 12 towards the position P3 (an example magnetic shield is depicted in FIG. 3B).

The final position P3 may be any distance away from the second magnet 12, but in an exemplary embodiment, the final position P3 is a location far enough away from the second magnet 12 such that the attractive force between the magnets 11 and 12 is substantially less (for example, less than 5%) of the attractive force between the magnets 11 and 12 when first magnet 11 is at position P2.

In the embodiment shown in FIGS. 1A and 1B, the first magnet 11 completes an energy-generation cycle by moving from the final position P3 to the initial position P1, where the first magnet 11 may begin a subsequent cycle. In the embodiment shown in FIGS. 1A and 1B, the entire energy-generation cycle is then repeated once the first magnet 11 returns to the initial position P1, which may result in the production of additional net energy as a result of the motion of the first magnet 11 during each successive movement cycle. The net energy that is output by motor 10 during each cycle is preferably transferred to an external device, such as an electric generator (not shown).

In some embodiments, a second portion of the energy stored in the aforementioned energy-storage device (shown, for example, as a spring in FIG. 2A) may be transferred back to the first magnet 11 to allow the first magnet 11 to move from the final position P3 towards the initial position P1, overcoming the relatively small magnetic attraction force acting between the magnets 11 and 12. In other embodiments, energy from an outside source (not shown) may be used to provide some or all of the energy required to move the first magnet 11 towards the initial position P1. In other embodiments (not shown), the first magnet 11 may still have some momentum in a direction towards the initial position P1 that may be used to assist the movement of the first magnet 11 towards the initial position P1.

As the first magnet 11 travels from the final position P3 towards the initial position P1, the motion of the first magnet 11 may be constrained by any mechanism, including those that are widely understood among those skilled in the art. For example, two guide rails may be used to constrain the motion of the first magnet 11, along a particular linear or nonlinear direction, as it travels from the position P3 towards the position P1.

The final position P3 may be any distance away from the initial position P1, but in preferred embodiments, the distance between the positions P3 and P1 may be optimized, depending on the strength of the attractive magnetic forces between the magnets 11 and 12 when the first magnet 11 is located at a particular position P3. The particular location of P3 may be optimally chosen, such that the net energy-yield of the motor 10 may be optimized for magnets 11 and 12 of a particular size, shape, and magnetic field strength. As the distance between the positions P3 and P2 increases, the attractive magnetic forces acting between the magnets 11 and 12 decreases, but if the position P3 is located too far away from the position P1, more energy must be expended to move the first magnet 11 from the position P3 back to the position P1 for the beginning of the next cycle.

In some embodiments, a third portion of the energy (net yield) stored in the aforementioned energy-storage device (i.e., the remainder that is not used to move the first magnet 11 from position P2 to position P3 and then back to position P1) may then be transferred to an external device, such as an electric generator (not shown). As shown in Appendix A-5, experimental test data demonstrate that there is sufficient energy produced by the embodiment shown in FIGS. 1A and 1B to allow for a net yield of energy to be transferred to an external device.

In this embodiment, the second magnet 12 remains stationary at the position P0 during the energy-generation cycle process steps, but any or all of the relative motion steps between the first magnet 11 and the second magnet 12 may be performed by either or both of the first magnet 11 and the second magnet 12. For example, the energy-generation step during which the two magnets 11 and 12 are brought closer together may be performed by moving the first magnet 11 towards the second magnet 12, while the step during which the two magnets 11 and 12 are separated may be performed by moving the second magnet 12 away from the first magnet 11 (an embodiment where the second magnet moves relative to the first magnet is shown in FIGS. 2A, 2B, and 2C).

FIG. 1C is a quantitative comparison of the magnetic force (in pounds) acting on the first magnet, at 1/32″ intervals, as it moves along the paths depicted in FIGS. 1A and 1B. Referring to FIG. 1C, a force comparison chart 30 includes a power stroke curve 31 and a separation stroke curve 32. The horizontal axis represents the horizontal distance (in direction D1) between the pole axes of the magnets 11 and 12 (for curve 31), and the vertical distance (in direction D2) between the magnets 11 and 12 (for curve 32), measured in 1/32″ units. The vertical axis represents the magnetic force acting on the first magnet 11, measured in pounds. The raw data displayed in the force comparison chart 30 can be seen in Appendices A-1 and A-2.

To generate the test data displayed in the force comparison chart 30, two magnets 11 and 12 were used, each made of neodymium (NdFeB), grade N38, with a nickel coating, each having an approximately cubic shape, measuring ¾″ in each dimension and weighing 1.83 ounces. A pull force of 43.40 pounds was used, and the surface field was 5,860 gauss. The average force values for three trials were used, and the values were adjusted to remove the friction drag force experienced by the first magnet 11 during the trials. The gap spacing 13 was set to be ⅛″ while the first magnet 11 traveled from the initial position P1 towards the intermediate position P2. The stagger spacing 14 was set to be 1/32″ while the first magnet traveled from the intermediate position P2 towards the final position P3.

Power stroke curve 31 depicts the magnetic force acting on the first magnet 11 as it travels from the initial position P1 (separated from the second magnet 12) to the intermediate position P2 (proximate the second magnet 12). As can be seen in FIG. 1C, during the power stroke curve 31, the attractive magnetic force acting on the first magnet 11 to pull it towards the second magnet 12 is initially low, when the first magnet 11 is greater than one inch away from the second magnet 12. As the first magnet 11 approaches the second magnet 12, the magnetic force increases, to a peak of approximately 0.32 pounds, when the poles of the magnets 11 and 12 are approximately 14/32″ apart. As the first magnet 11 continues to approach the intermediate position P2 (proximate the second magnet 12), the magnetic force drops, eventually reaching a level of approximately 0.10 pounds, less than one-third that at the peak. In FIG. 1C, the total energy generated during the movement of the magnet 11 from the position P1 to the position P2 can be calculated to be 7.60 inch-pounds of work, which is equal to the area under the power stroke curve 31.

In this embodiment, if a user desires to store (for example, in an energy-storage device such as a spring, as shown in FIGS. 2A, 2B, and 2C) substantially all of the kinetic energy produced by the magnet 11 as it travels from the position P1 to the position P2, the reduction of the force acting on the first magnet 11 after the peak force level is reached may make advantageous the use of one or more components of motor 10 that are correlated or tuned to the shape of the power stroke curve 31. An example of such a component that is correlated to the shape of the power stroke curve 31 in a particular motor 10 is a non-circular pulley including a variable-leverage arm profile, which is shown in FIGS. 2A, 2B, and 2C. However, in other embodiments, circular pulleys, gears having a circular or non-circular shape, or other energy-transfer components for the first magnet may be used.

Separation stroke curve 32 depicts the magnetic force acting on the first magnet 11 as it travels from the intermediate position P2 (proximate the second magnet 12) to the final position P3 (separated from the second magnet 12). As can be seen in FIG. 1C, during the separation stroke curve 32, the attractive magnetic force acting on the first magnet 11 from the second magnet 12 is initially high, when the first magnet 11 is less than a quarter-inch away from the second magnet 12. The magnetic force acting on the first magnet 11 starts at a peak of approximately 0.63 pounds when magnets 11 and 12 are approximately 1/32″ apart. This peak magnetic force seen in the direction D2, during the separation stroke curve 32 is almost twice the peak magnetic force seen in the direction D1, during the power stroke curve 31. As the first magnet 11 continues to approach the final position P3 (separated from the second magnet 12), the magnetic force drops, eventually reaching a level of approximately 0.04 pounds. In FIG. 1C, the total energy expended during the movement of the magnet 11 from the position P2 to the position P3 can be calculated to be 6.21 inch-pounds of work, which is equal to the area under the separation stroke curve 32.

In this embodiment, if a user has stored substantially all of the kinetic energy produced by the motion of the first magnet 11 during the power stroke curve 31, the user may use a first portion of this stored energy to drive the motion of the first magnet 11 in the direction D2, away from the second magnet 12, during the separation stroke curve 32. If a first portion of this stored energy is used during the separation stroke curve 32, a net energy yield of approximately 0.90 inch-pounds is produced after the first magnet 11 has moved from the initial position P1, to the intermediate position P2, and then to the final position P3. If second portion of the stored energy is used to return the first magnet 11 back to the initial position P1, there may be a substantial third portion of this net energy yield of 0.90 inch-pounds that is available to be transferred to an external device, such as an electric generator.

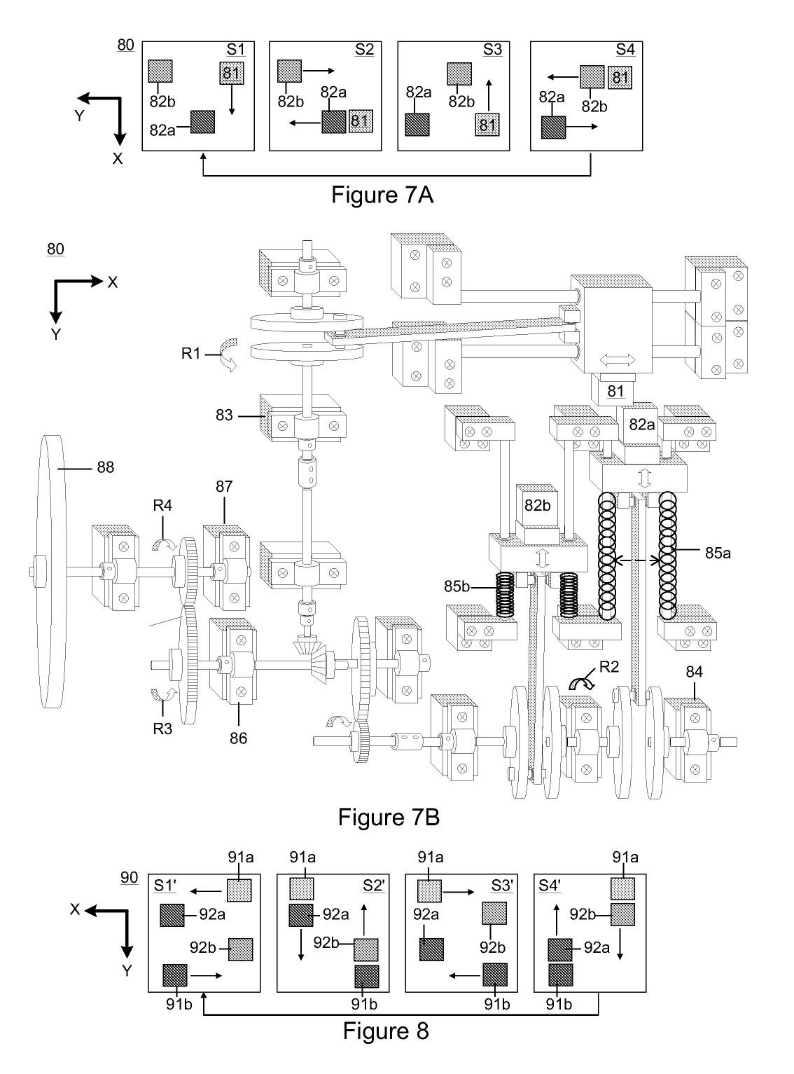

FIGS. 2A, 2B, and 2C are diagrammatic views of three positions within a single energy-generating cycle of an exemplary linear permanent magnet motor, comprising two moveable permanent magnets and an energy-storage device including a non-circular pulley including a variable-leverage arm profile coupled to a spring, illustrating a second embodiment of the invention. Referring to FIGS. 2A, 2B, and 2C, a permanent magnet motor 40 includes a first magnet 41, a second magnet 42, a first pulley 43a (preferably non-circular with a variable-leverage arm profile), a second pulley 43b (may be circular or non-circular), a first belt 44a, a second belt 44b, a first switch 45a, a second switch 45b, and an energy-storage device 46 (shown in FIGS. 2A-2C as a spring). In alternative embodiments (for example, as shown in FIG. 7B), the first pulley 43a and the second pulley 43b may be either circular or non-circular gears, either or both of which may incorporate a variable-leverage arm profile.

In the embodiment of permanent magnet motor 40 depicted in FIGS. 2A-2C, two permanent magnets 41 and 42 are used to generate energy, which preferably is transferred to an external device (not shown), such as an electric generator. The energy-generation process depicted in FIGS. 2A-2C has an initial state, in which the first magnet 41 is located at an initial horizontal position H1, the second magnet 42 is located at an initial vertical position V1, the energy-storage device 46 (e.g., shown as a spring in FIGS. 2A-2C) is in a compressed position, the first switch 45a is disengaged (i.e., allowing rotation of the first pulley 43a), and the second switch 45b is engaged (i.e., preventing rotation of the second pulley 43b).

While the motor 40 is in the initial state, as well as throughout the energy-generation process of motor 40, the poles of the magnets 41 and 42 preferably have approximately the same relative orientation, such that lines drawn from the north to south pole (pole axes) of each magnet 41 and 42 are approximately parallel. In some embodiments, the pole axes of the magnets 41 and 42 may be arranged such that they are not parallel, but the inventor theorizes that a parallel orientation of the pole axes of the magnets 41 and 42 may produce a higher energy net yield for the motor 40. In some embodiments, the relative orientation of the pole axes of magnets 41 and 42 may change during the energy-generation process. For example, the pole axes of magnets 41 and 42 may be parallel while motor 40 is in the initial state, but the pole axes of magnets 41 and 42 may not be parallel at intermediate steps during the energy-generation process.

While the motor 40 is in the initial state, as well as throughout the energy-generation process of motor 40, the poles of the magnets 41 and 42 preferably are oriented such that the attractive magnetic force between the magnets 41 and 42 is the dominant magnetic force acting on the magnets 41 and 42. In other embodiments (not shown), the repulsive magnetic force between the magnets 41 and 42 may be the dominant magnetic force acting on the magnets 41 and 42. In other embodiments (not shown), a combination of attractive and repulsive magnetic forces between the magnets 41 and 42 may be used during the power-generation process of the motor 40.

In an exemplary embodiment, the first magnet 41 and the second magnet 42 are permanent magnets made of neodymium (NdFeB), a material developed by Hitachi Metals. In an exemplary embodiment, the first magnet 41 and the second magnet 42 are approximately the same size, shape, and of the same magnetic field strength. However, in other embodiments, the relative size, shape, and magnetic field strength of the first magnet 41 and the second magnet 42 may vary, depending on the particular desired energy-yield performance of motor 40. In an exemplary embodiment, each of the first magnet 41 and the second magnet 42 are relatively flat in shape and have a rectangular cross-section, with the height of each magnet 41 and 42 being the shortest dimension, compared with the length and width. In other preferred embodiments, cubic-shaped magnets 41 and 42 are used.

As shown in FIG. 2A, the first magnet 41 is initially placed at an initial horizontal position H1 that is close enough to the second magnet 42, which is initially placed at an initial vertical position V1, such that the attractive magnetic force between the magnets 41 and 42 is strong enough to overcome any inertia and/or friction forces preventing the first magnet 41 from beginning to move. This initial distance between the magnets 41 and 42 may vary, depending on the particular application and dimensions of the motor 40.

Once the attractive magnetic force between the magnets 41 and 42 overcomes the inertia force and begins to move the first magnet 41 towards the second magnet 42, the first magnet 41 travels in a direction D1′ towards a final horizontal position H2. As shown in FIG. 2B, the direction D1′ is a first linear direction (horizontal direction) that is approximately perpendicular to the orientation of the poles (vertical direction) of the first magnet 41 and the second magnet 42. The motion of the first magnet 41 preferably may be constrained along the direction D1′ by any mechanism, including those that are widely understood among those skilled in the art. For example, as shown in FIGS. 2A-2C, two guide rails may be used to constrain the motion of the first magnet 41, along a particular linear or nonlinear direction towards second magnet 42.

In the embodiment depicted in FIGS. 2A-2C, the first magnet 41 travels in the direction D1′ towards the second magnet 42. In other embodiments, the first magnet 41 and the second magnet 42 may both travel towards each other at the same time, the first magnet 41 traveling in the direction D1′, and the second magnet 42 traveling in a direction opposite the direction D1′.

In the preferred embodiment shown in FIGS. 2A-2C, the direction D1′ is linear. In other embodiments, the direction D1′ may be non-linear or curvilinear. The exact path that the first magnet 41 takes as it travels from the initial horizontal position H1 towards the final horizontal position H2 may vary, based on the desired size, shape, and desired net energy-yield and other performance characteristics of motor 40.

In some embodiments, energy from an outside source (not shown), or a switch mechanism (e.g., a mechanical, electrical, or magnetic switch), or both, may be used to provide some or all of the energy required to overcome the inertia force to begin to move the first magnet 41 from the initial horizontal position H1 towards the final horizontal position H2. In other embodiments (not shown), the first magnet 41 may still have some remaining momentum in the direction D1′ from a previous energy-generation cycle that may be used to begin the motion of the first magnet 41 from the initial position H1 towards the final position H2.

While the first magnet 41 moves from the initial horizontal position H1 to the final horizontal position H2, towards the second magnet 42, the kinetic energy produced by the motion of the first magnet 41 may be transferred to the energy-storage device 46, shown as a spring in FIGS. 2A-2C, which preferably stores substantially all of the kinetic energy produced by the motion of the first magnet 41. The energy-storage device preferably is a spring, but the energy-storage device may also be any other energy-storage device understood among those skilled in the art.

In this embodiment, the first magnet 41 is coupled to the energy-storage device 46 via the first belt 44a (which may be a belt, wire, or any other coupling linkage) that is preferably wrapped around a portion of the first pulley 43a, which preferably is a non-circular pulley including a variable-leverage arm profile. As described above, it is preferable that the profile or shape of the first pulley 43a should be correlated to the shape of the magnetic force v. distance curve experienced by the first magnet 41 during an energy-production cycle.

This fine-tuning of the profile or shape of the first pulley 43a (by matching the profile of the first pulley 43a to the shape of the force curve experienced by the first magnet 41) may allow a higher percentage of the kinetic energy produced by the motion of the first magnet 41 to be stored in the energy-storage device 46. In other embodiments, the first pulley 43a may be a circular pulley or another coupling mechanism that is adapted to transfer the kinetic energy produced by the motion of the first magnet 41 to the energy-storage device 46. A first pulley 43a with a variable-leverage arm profile may maximize the amount of kinetic energy that can be stored or transferred during the operation of motor 40.

Although a first pulley 43a (preferably non-circular with a variable-leverage arm profile) is depicted in the second embodiment depicted in FIGS. 2A-2C and described in the other embodiments shown in the remainder of FIGS. 1A-5, other variable leverage mechanisms may be used. For example, instead of or in addition to a first pulley 43a including a variable-leverage arm profile, motor 40 may include a variable spring mechanism, a gear or gears that may or may not have variable-leverage profiles (for example, as shown in FIG. 7B), or any other variable-force mechanism known in the art.

Although it is preferable that the profile (preferably a variable-leverage arm profile) of the first pulley 43a be correlated to the shape of the magnetic force v. distance curve experienced by the first magnet 41 during an energy-production cycle, and coupled to a spring 46 (as shown in FIGS. 2A-2C), this correlation and coupling may be accomplished by a variable spring mechanism, which may replace the spring 46 and the first pulley 43a. In such an embodiment incorporating a variable spring mechanism (not shown), while the first magnet 41 moves from initial horizontal position H1 to final horizontal position H2, this kinetic energy can be transferred to a variable spring mechanism (not shown) via the first belt 44a. This variable spring mechanism preferably would be correlated to the shape of the magnetic force v. distance curve experienced by the first magnet 41 as it moves from position H1 to position H2 during an energy-production cycle. In this manner, the variable spring mechanism may store substantially all of the energy produced by the motion of the first magnet 41 during the power stroke cycle.

While the first magnet 41 moves from the initial horizontal position H1 to the final horizontal position H2, the energy-storage device 46, which is a spring in this embodiment, begins to receive (via the first belt 44a) and store the kinetic energy from the motion of the first magnet 41. As the first magnet 41 moves, the first pulley 43a begins to rotate in a rotational direction R1, which in this embodiment is a clockwise direction. In the case where the energy-storage device 46 is a spring, the spring begins to stretch, converting the kinetic energy of the first magnet 41 into potential energy, stored in the coils of the spring. In other embodiments, other energy-storage devices 46 may be used, including electrical storage mechanisms such as a capacitor and other mechanical or non-mechanical storage mechanisms.

In order for the motion of the first magnet 41 from initial horizontal position H1 to final horizontal position H2 to sufficiently stretch the spring such that it stores the kinetic energy produced by the motion of the first magnet 41, the second switch 45b must be engaged (locked). If the second switch 45b is unengaged (open), then the spring will not store much energy. Instead, the energy transferred to the spring via the first belt 44a will pass through the spring, and through the second belt 44b (which may be a belt, wire, or any other coupling linkage), to begin to move the second magnet 42 in the D2′ direction (shown in FIG. 2C) before the first magnet 41 has reached the proper location at the final position H2. On the other hand, if the second switch 45b is properly engaged while the first magnet 41 moves from position H1 to position H2, the energy transferred to the spring via the first belt 44a will stretch the spring, storing the kinetic energy as potential energy, so that the energy can later be used to move the second magnet 42 when the first magnet 41 has reached the final horizontal position H2.

As can be seen in FIG. 2B, when the first magnet 41 reaches the final horizontal position H2, proximate the second magnet 42, the first magnet 41 and the second magnet 42 preferably are at the closest distance to each other that they reach during the operation of this embodiment of motor 40. As shown in FIG. 2B, the relative closest approach locations of the first magnet 41 at final horizontal position H2 and the second magnet 42 at initial vertical position V1 are determined by the gap spacing (vertical distance between the magnets 41 and 42, not shown in FIGS. 2A-2C, but represented by gap spacing 13 in FIG. 1A) and the stagger spacing (horizontal distance between the pole axes of magnets 41 and 42, not shown in FIGS. 2A-2C, but represented by stagger spacing 14 in FIG. 1A).

As mentioned above, the gap spacing (not shown in FIGS. 2A-2C) between the first magnet 41 and the second magnet 42 may be any distance, depending on the particular relative dimensions of the components of motor 40 and the particular desired net energy-production performance requirements of motor 40. Preferably, the gap spacing is greater than zero, because a gap spacing of zero may result in a very high required initial force to begin to separate the first magnet 41 and the second magnet 42. As mentioned above, the stagger spacing (not shown in FIGS. 2A-2C) between the first magnet 41 and the second magnet 42 may be any distance, depending on the particular relative dimensions of the components of motor 40 and the particular desired net energy-production performance requirements of motor 40. Preferably, the stagger spacing is greater than zero, because there is an inverse relationship between the stagger spacing and the required initial force to begin to separate the magnets 41 and 42.

When the first magnet 41 reaches the final horizontal position H2, the energy-storage device 46 (shown as a spring) may be fully loaded with energy. In embodiments where the energy-storage device 46 is a spring, the spring may be fully stretched when the first magnet 41 is located at the final horizontal position H2. At this point, the portion of the cycle that generates energy that may be transferred to an external device may be completed. In this embodiment (shown in FIGS. 2A-2C), part of the stored energy may be used to separate the first magnet 41 and the second magnet 42 and then return the motor 40 to its initial position to begin another energy-generation cycle. In other embodiments, there may be multiple sets of magnets 41 and 42, so more energy may be generated from other sets of magnets 41 and 42 while the first set of magnets 41 and 42 proceeds through the rest of the process to return their initial positions.

As can be seen in FIG. 2C, after the first magnet 41 reaches final horizontal position H2, proximate the second magnet 42, the second magnet 42 travels away from the first magnet 41 in a direction D2′ towards a final vertical position V2. In the embodiment shown in FIGS. 2A-2C, the second magnet 42 is moved away from the first magnet 41. However, in other embodiments (such as the embodiment shown in FIGS. 1A-1B), the first magnet may be moved away from the second magnet. Either or both of the magnets 41 and 42 may be moved apart from each other, preferably in the direction D2′ which is approximately parallel to the pole axes of the magnets 41 and 42. The choice of which of the magnets 41 and 42 will be moved during any particular step of the energy-generation process will be based on the desired size, shape, and desired net energy-yield and other performance characteristics of motor 40.

The direction D2′ is a second linear direction (vertical direction) that is approximately parallel to the pole axes of the first magnet 41 and the second magnet 42. The motion of the second magnet 42 preferably may be constrained along the direction D2′ by any mechanism, including those that are widely understood among those skilled in the art. For example, as shown in FIGS. 2A-2C, two guide rails may be used to constrain the motion of the second magnet 42, along a particular linear or nonlinear direction away from the first magnet 41.

In the embodiment depicted in FIGS. 2A-2C, the second magnet 42 travels in the direction D2′ away from the first magnet 41. In other embodiments, the first magnet 41 and the second magnet 42 may both travel towards each other at the same time, the second magnet 42 traveling in the direction D2′, and the first magnet 41 traveling in a direction opposite the direction D1′.

In the preferred embodiment shown in FIGS. 2A-2C, the direction D2′ is linear. In other embodiments, the direction D2′ may be non-linear or curvilinear. The exact path that the second magnet 42 takes as it travels from the initial vertical position V1 towards the final vertical position V2 may vary, based on the desired size, shape, and desired net energy-yield and other performance characteristics of motor 40.

In this embodiment, the motion of the second magnet 42 from the initial vertical position V1 to the final vertical position V2 is counter to the magnetic attraction forces acting between the first magnet 41 and the second magnet 42. During the movement of the second magnet 42 from the initial vertical position V1 to the final vertical position V2, the magnetic attraction force between the first magnet 41 and the second magnet 42 is strongest when the magnets 41 and 42 are closest to each other, i.e., when the first magnet 41 is in the final horizontal position H2 and the second magnet is in the initial vertical position V1. Therefore, in this embodiment, a separation force must be exerted on the second magnet 42 to counter the magnetic attraction forces, while the second magnet 42 is in the initial vertical position V1, to permit the beginning of the separation of the magnets 41 and 42. In this embodiment, there may be a required amount of force to overcome the inertia force in the direction D2′ to allow the second magnet 42 to begin to move towards the final vertical position V2.

In preferred embodiments, a first portion of the energy stored in the energy-storage device 46 (shown as a spring in FIGS. 2A-2C) may be transferred to the second magnet 42 to allow the second magnet 42 to move towards the final vertical position V2, overcoming the inertia force and magnetic attraction force acting on it in the direction D2′. In the embodiment shown in FIGS. 2A-2C, where the energy-storage device 46 is a spring, the potential energy stored in the spring 46 is transferred to the second magnet 42 via the second belt 44b.

In order for the energy-storage device 46 to transfer energy to the second magnet 42 while the first magnet 41 remains substantially stationary, the first switch 45a preferably is engaged (i.e., preventing rotation of the first pulley 43a), and the second switch 45b is disengaged (i.e., allowing rotation of the second pulley 43b). This orientation of the first switch 45a and the second switch 45b is shown in FIGS. 2B and 2C. With the first switch 45a engaged and the second switch 45b disengaged, the spring 46 begins to compress, which pulls on the second belt 44b that rotates the second pulley 43b in a rotational direction R2 (which is clockwise in this embodiment). As the spring 46 compresses, the potential energy of the spring 46 is transferred via the second belt 44b to the second magnet 42, causing the second magnet 42 to move in the direction D2′ towards the final vertical position V2. In other embodiments, energy from an outside source (not shown) may be used to provide some or all of the energy required to move the second magnet 42 towards the final vertical position V2 or to assist the energy-storage device in the task of moving the second magnet 42 towards the final vertical position V2.

While the second magnet 42 moves from the initial vertical position V1 to the final vertical position V2, the stagger spacing 14 between the pole axes of the first magnet 41 and the second magnet 42 preferably is maintained. However, in some embodiments, the direction D2′ along which the second magnet 42 travels as it moves from position V1 to position V2 may be non-linear. In these embodiments, the stagger spacing 14 may be increased or decreased as the second magnet 41 travels towards the final vertical position V2.

In some embodiments, a magnetic shield may be applied to a portion of the first magnet 41 and/or the second magnet 42 to alter the magnetic field of the magnets 41 and 42, thereby reducing the force and/or energy required to pull the second magnet 42 away from the first magnet 41 towards the final vertical position V2 (an example magnetic shield is depicted in FIG. 3B).

The final vertical position V2 may be any distance away from the first magnet 41, but in an exemplary embodiment, the final vertical position V2 is a location far enough away from the first magnet 41 such that the attractive force between the magnets 41 and 42 is less than 5% of the attractive force between the magnets 41 and 42 when second magnet 42 is at the initial vertical position V1. In preferred embodiments, the distance between the positions V1 and V2 may be optimized, depending on the strength of the attractive magnetic forces between the magnets 41 and 42 when the second magnet 41 is located at a particular final vertical position V2. The particular location of the position V2 may be optimally chosen, such that the net energy-yield of the motor 40 may be optimized for magnets 41 and 42 of a particular size, shape, and magnetic field strength. As the distance between the positions V1 and V2 increases, the attractive magnetic forces acting between the magnets 41 and 42 decreases, but if the position V2 is located too far away from the position V1, more energy must be expended to move the second magnet 42 from the position V1 back to the position V1 for the beginning of the next cycle.

When each energy-generation cycle is completed, all components of the motor 40 preferably are returned to their initial positions. In the embodiment shown in FIGS. 2A-2C, an energy-generation cycle is completed by moving the first magnet 41 back to the initial horizontal position H1 and moving the second magnet 42 back to the initial vertical position V1, where the magnets 41 and 42 may begin a subsequent cycle. The entire energy-generation cycle is then repeated once the magnets 41 and 42 return to their respective initial positions H1 and V1, which may result in the production of additional net energy as a result of the motion of the first magnet 41 (producing kinetic energy in this embodiment) during each successive movement cycle.

In preferred embodiments, a second portion of the energy stored in the energy-storage device 46 (shown as a spring in FIGS. 2A-2C) may be transferred to the first magnet 41 and the second magnet 42 to allow the magnets 41 and 42 to return to their respective initial positions H1 and V1, providing the required kinetic energy and overcoming the relatively small magnetic attraction force differential acting between the magnets 41 and 42 in their respective final positions H2 and V2 versus their respective initial positions H1 and V1 (due to the spatially-uneven magnetic fields surrounding the magnets 41 and 42). This potential energy is transferred from the spring 46 to the second magnet 42 by the spring 46 undergoing compression, which converts the second portion of the stored energy from potential energy into kinetic energy.

In some embodiments, the energy required to move the magnets 41 and 42 to return to their respective initial positions H1 and V1 may be supplied by additional energy-storage devices (shown in FIG. 7B, for example, as springs 85a and 85b) that are coupled to the magnets 41 and 42. While the magnets 41 and 42 move from their respective initial positions H1 and V1 to their respective final positions H2 and V2, the additional energy-storage devices or springs are stretched. When the magnets 41 and 42 reach their respective final positions H2 and V2, the small amount of potential energy stored in the additional energy-storage devices or springs is used to pull the magnets 41 and 42 back to their respective initial positions H1 and V1. In other embodiments, energy from an outside source (not shown) may be used to provide some or all of the energy required to return the magnets 41 and 42 to their respective initial positions H1 and V1.

In preferred embodiments, a third portion of the energy (net yield) stored in the energy-storage device 46 (i.e., the remainder that is not used to move the magnets 41 and 42 from their respective final positions H2 and V2 back to their respective initial positions H1 and V1) may be transferred out of the motor 40 to an external device, such as an electric generator (not shown) or a flywheel (an example flywheel 88 is shown in FIG. 7B). In the embodiment shown in FIGS. 2A-2C, when the first pulley 43a is rotated in the direction R1 during the power stroke (when the first magnet 41 moves towards the second magnet 42, assisted by attractive magnetic forces between the magnets 41 and 42), a portion of the kinetic energy transferred to the first pulley 43a may be transferred to a shaft (not shown) coupled to the rotational center of the first pulley 43a and coupled to an external device, such as an electric generator or a flywheel.

In some embodiments, the second portion and the third portion of the energy stored in the storage device 46 may be transferred to their respective targets simultaneously, or the second portion may be transferred first, or the third portion may be transferred first. In embodiments where energy-storage device 46 is a spring, the second portion of the energy may be transferred to the second magnet 42 via the second belt 44b while the third portion of the energy may be transferred via a coupling mechanism (such as a crankshaft or any other coupling mechanism known in the art, not shown) to an external device (not shown). In some preferred embodiments, the transfer of the second portion and the third portion of the energy may be transferred during a single compressing motion of the spring 46. In other preferred embodiments, the second portion of the energy is transferred to the second magnet 42 during a first, partial compressing motion of the spring 46, after which some potential energy still remains in the spring 46. Then, the third portion of the energy is transferred to an external device during a second, further compressing motion of the spring 46, after which no significant potential energy remains in the spring 46.

In order for the magnets 41 and 42 to return to their respective initial positions H2 and V2, the first switch 45a and the second switch 45b preferably are disengaged (i.e., allowing rotation of the respective first pulley 43a and the second pulley 43b). With the first switch 45a engaged and the second switch 45b disengaged, the spring 46 begins to compress, which pulls on the second belt 44b that rotates the second pulley 43b in a rotational direction R2 (which is clockwise in this embodiment). As the spring 46 compresses, the potential energy of the spring 46 is transferred via the second belt 44b to the second magnet 42, causing the second magnet 42 to move in the direction D2′ towards the final vertical position V2. In other embodiments, energy from an outside source (not shown) may be used to provide some or all of the energy required to move the second magnet 42 towards the final vertical position V2 or to assist the energy-storage device in the task of moving the second magnet 42 towards the final vertical position V2.

FIG. 2D is a qualitative comparison of the magnetic force acting on the first magnet as it moves along the path depicted in FIGS. 2A and 2B, and the force required to load or stretch the energy-storage device depicted in FIGS. 2A and 2B as the first magnet moves.

Referring to FIG. 2D, a force comparison chart 47 includes a power stroke force curve 48a and an energy-storage device force curve 48b. The horizontal axis represents the horizontal distance (in direction D1′) traveled by the first magnet 11 as it moves from the initial position H1 to the final position H2 (during the power stroke process depicted in FIGS. 2A and 2B). The vertical axis represents the magnetic force acting on the first magnet 11 (that may be transferred to the energy-storage device 46) and the force required to load or stretch the energy-storage device 46 (depicted as a spring in FIGS. 2A and 2B). The intermediate positions 49a through 49f are positions of the first magnet 11 (distances from the initial position H1) as it moves from the initial position H2 to the final position H2.

As can be seen in FIG. 2D, the power stroke force curve 48a has a non-linear shape. This non-linear shape of the power stroke force curve 48a reflects the non-linear variation in the magnetic force acting on the first magnet 41 as it moves from the initial position H1 to the final position H2 (as shown in FIGS. 2A and 2B). However, in some embodiments, the energy-storage device force curve 48b may have a more linear shape. This more linear shape of the energy-storage device force curve 48b reflects the more linear variation in the force required to continue to stretch the energy-storage device or spring 46 (to store increasing amounts of energy) as the first magnet 41 moves from the position H1 to the position H2.

As is evident in FIG. 2D, the force acting on the first magnet 41 at any given distance from the position H1 during its horizontal travel (at intermediate positions 49a through 49f) may be different that the force required to stretch the spring 46 the same distance. If a circular first pulley 43a is used, this mismatch in the force acting on the first magnet 41 versus the force required to stretch the spring 46 the same distance may result in some kinetic energy produced by the motion of the first magnet 41 not being stored (i.e., inefficiency). In order to store substantially all of the kinetic energy produced from the motion of the first magnet 41 as it travels from the position H1 to the position H2 (power stroke), it may be beneficial to include a variable-leverage arm profile in the first pulley 43a (as shown in FIGS. 2A-2C and in more detail in FIGS. 2E-2F). Such a first pulley 43a including a variable-leverage arm profile, tuned to the shapes of the power stroke force curve 48a and the energy-storage device force curve 48b, may allow a higher percentage of the energy produced by the motion of the first magnet 41 to be stored by the spring 46.

FIGS. 2E and 2F are diagrammatic views of two rotational orientations of an exemplary non-circular first pulley 43a having a variable-leverage arm profile, in the embodiment depicted in FIGS. 2A-2C.

Referring to FIGS. 2E and 2F, an exemplary non-circular first pulley 43a having a variable-leverage arm profile includes a first cam half 43c, a second cam half 43d, a center of rotation 43e, a first cam half belt 44c, and a second cam half belt 44d. The first cam half 43c includes the lever arms 49a′ through 49f, which correlate to the desired leverage for the first pulley 43a at the intermediate positions 49a through 49f of the first magnet 11 (distances from the initial position H1) as it moves from the initial position H2 to the final position H2. The second cam half 43d includes the lever arms 49a″ through 49f′, which also correlate to the desired leverage for first pulley 43a at the intermediate positions 49a through 49f of the first magnet 11. FIG. 2E depicts the non-circular first pulley 43a in an initial position, while FIG. 2F depicts the non-circular first pulley 43a in a final position, rotated about the center of rotation 43e in a rotational direction R1.

In order to store substantially all of the kinetic energy produced from the motion of the first magnet 41 as it travels from the position H1 to the position H2 (power stroke), it may be beneficial to tune the variable-leverage arm profile of the first pulley 43a to the shapes of the power stroke force curve 48a and the energy-storage device force curve 48b. In the exemplary embodiment of the first pulley 43a shown in FIGS. 2E-2F, this profile-tuning may be accomplished by providing first cam half 43c lever arms 49a′ through 49f and second cam half 43d lever arms 49a″ through 49f′. Levers (lever arms, gears, pulleys, etc.) allow for reshaping the force output from the first magnet 41 delivered by a given amount of kinetic energy.

At the intermediate position 49a, for example, the energy-storage device force curve 48b is above the power stroke force curve 48a. Therefore, the lever arm 49a′ should be longer than the corresponding lever arm 49a″. This leverage may be beneficial, because the force acting on the first magnet 41 may be applied to the spring 46 over a smaller distance, which may allow a higher percentage of the energy produced from the motion of the first magnet 41 to be stored in the spring 46. At the intermediate position 49d, for example, the energy-storage device force curve 48b is approximately equal to the power stroke force curve 48a. Therefore, the lever arm 49d′ should be approximately the same as the corresponding lever arm 49d″, because relatively little leverage is needed at this point in the travel of the first magnet 41.

As can be seen in FIGS. 2E and 2F, the non-circular first pulley 43a may include a first cam half 43c and a second cam half 43d. This double half-cam design may allow the first cam half 43c to be positioned above or below (in a different two-dimensional plane) than the second cam half 43d. The reason for this relative positioning of the first cam half 43c and the second cam half 43d is so the first cam half belt 44c and the second cam half belt 44d only contact the first pulley 43a in one section of each respective belt.

As can be seen in FIGS. 2E and 2F, the second cam half belt 44d would eventually contact the first cam half 43c as the first pulley 43a rotates in the rotation direction R1 from the initial position shown in FIG. 2E to the final position shown in FIG. 2F. This additional contact may partially compromise the tuning of the force curves 48a and 48b, because the lever arms 49a′ through 49f and 49a″ through 49f′ act at the last point of contact of the cam half belts 44c and 44d with the respective cam halves 43c and 43d. For example, as shown in FIG. 2F, in order to achieve the appropriate ratio of length of 49f and 49f′, which should be correlated to the ratio of force curves 48a and 48b at intermediate position 49f, the last point of contact of the second cam half belt 44d with the first pulley 43a should be at the lever arm 49f′. However, if the two cam halves 43c and 43d were in the same two-dimensional plane, then the second cam half belt 44d would contact the first cam half 43c. This potential point of additional contact can be seen in FIG. 2F, where the second cam half belt 44d passes over or under the first cam half 43c at the lever arm 49b′. The first pulley 43a design shown in FIGS. 2E and 2F allows the second cam half belt 44d to avoid contacting the first cam half 43c, thus preserving the tuning of the cam halves 43c and 43d to the force curves 48a and 48b.

In some embodiments (for example, as shown in FIGS. 2D-2F), most of the energy required to move a second magnet 42 away from the first magnet 41 may be stored in a spring 46 for later transfer to the second magnet 42. In other embodiments (for example, as shown in FIG. 7B), most of the energy required to move one or more second magnets away from the first magnet (separation stroke) may be transferred directly from the first magnet, with relatively little energy storage. In these lower-energy-storage embodiments, it may be beneficial to tune the variable-leverage arm profile of the first pulley 43a to the shapes of the power stroke force curve 48a (shown as power stroke curve 31 in FIG. 1C) and the separation stroke force curve (not shown in FIG. 2D, but shown as separation stroke curve 32 in FIG. 1C).

As can be seen in FIG. 1C, the separation stroke curve 32 is initially higher then the power stroke curve 31 (at small distances between the first and second magnets), and at other points, the power stroke curve 31 is higher then the separation stroke curve 32 (at larger distances between the first and second magnets). When the power stroke curve is higher than the separation stroke curve, the lever arm, for example 49a′ (coupled to the first magnet by the first cam half belt 44c), may be longer than the corresponding lever arm, for example 49a″ (coupled by the second cam half belt 44d to the target force recipient, such as the second magnet). When the power stroke curve is lower than the separation stroke curve, the lever arm, for example 49d′ (coupled to the first magnet by the first cam half belt 44c), may be shorter than the corresponding lever arm, for example 49d″ (coupled by the second cam half belt 44d to the target force recipient, such as the second magnet).

FIGS. 3A and 3B are diagrammatic views of the shape of the magnetic field and direction of field lines surrounding a stationary permanent magnet, with and without the use of magnetic shielding around a portion of the stationary permanent magnet, respectively, illustrating a third embodiment of the invention.

Referring to FIGS. 3A and 3B, a permanent magnet motor 50 includes a first magnet 51, a second magnet 52, and an optional magnetic shield 53. In FIG. 3A, which does not include an optional magnetic shield 53, second magnet 52 defines approximately equivalently-shaped magnetic field portions 54a and 54b. In FIG. 3B, which includes an optional magnetic shield 53, second magnet 52 defines unevenly-shaped (relative to each other) magnetic field portions 54b and 54c. In some embodiments (shown, for example, in FIG. 3B) a magnetic shield may be applied to a portion of the first magnet 51 and/or the second magnet 52 to alter the magnetic field of the magnets 51 and 52, thereby reducing the force and/or energy required to pull the 51 and 52 apart from each other.

In FIG. 3A, magnetic field portions 54a and 54b are approximately equivalently-shaped. When an optional magnetic shield 53 is applied to the second magnet 52, for example, as shown in FIG. 3B, the left magnetic field portion 54a is altered and takes the shape of left magnetic field portion 54c. In FIG. 3B, the path taken by the magnetic field force lines on the left side of the second magnet 52 are altered, being pulled closer to the surface of the second magnet 52. This increases the unevenly-distributed magnetic forces acting on the first magnet 51 as the motor 50 goes through the energy-generation process steps. When the optional magnetic shield 53 is used (for example, as in FIG. 3B), the force required to separate the first magnet 51 and the second magnet 52 may be decreased (compared to FIG. 3A), and the net energy yield produced by the motor 50 may be increased for a particular size, weight, and configuration of magnets 51 and 52.

FIG. 4 is a diagrammatic view of an exemplary linear permanent magnet motor, comprising three pairs of moveable permanent magnets coupled to a single crankshaft, each magnet pair performing a different step of the energy-generation process at any given time, illustrating a fourth embodiment of the invention.

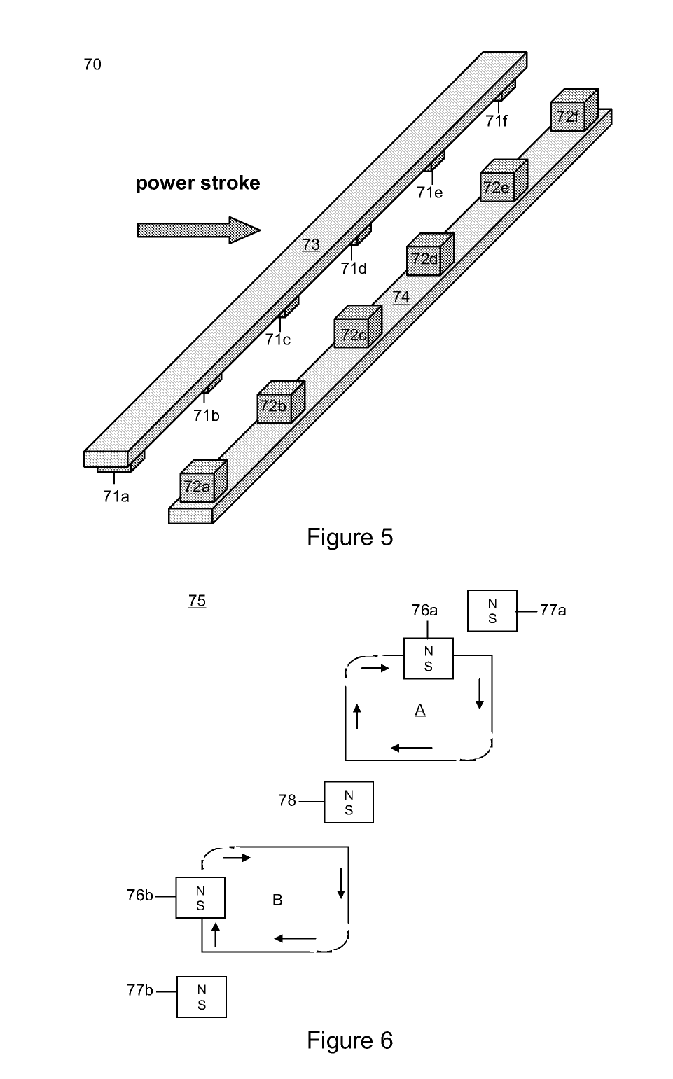

Referring to FIG. 4, a permanent magnet motor 60 includes first magnets 61a, 61b, and 61c, second magnets 62a, 62b, and 62c, and a crankshaft 63. As shown in FIG. 4, an exemplary embodiment of permanent magnet motor 60 includes three pairs of permanent magnets, each pair going through its own energy-generation process. For the motion of a particular pair of a first magnet 61 and a second magnet 62, any embodiment can be used to govern the energy-generation process steps, for example, the first embodiment shown in FIGS. 1A-1C, the second embodiment shown in FIGS. 2A-2C, the fifth embodiment shown in FIG. 5 (discussed below), or any other embodiment according to the aforementioned discussion may be used.

The exemplary motor 60 shown in FIG. 4 is based on the motion of three magnet pairs, each one using a process generally according to the second embodiment shown in FIGS. 2A-2C. The motions of the first magnet 41 and the second magnet 42 in FIGS. 2A-2C may be broadly categorized into a power stroke (when the first magnet 41 moves towards the second magnet 42, traveling from initial horizontal position H1 to final horizontal position H2), a separation stroke (when the second magnet 42 moves away from the first magnet 41, traveling from initial vertical position V1 to final vertical position V2), and a return stroke (when the first magnet 41 and the second magnet 42 return to their respective initial positions H1 and V1). The motions of the magnets in FIGS. 1A-1C may also be categorized into a power stroke (e.g., power stroke curve 31), a separation stroke (e.g., separation stroke curve 32), and a return stroke.

In the embodiment depicted in FIG. 4, at any given time, one of the three magnet pairs is in each of the three steps: the power stroke, the separation stroke, and the return stroke. As shown in FIG. 4, the first set of magnets 61a and 62a is in the power stroke step, the second set of magnets 61b and 62b is in the separation stroke step, and the third set of magnets 61c and 62c is in the return stroke step. All three of these magnet pairs having a first magnet 61 and a second magnet 62 may be coupled to a single crankshaft 63 through which energy may be transferred to an external device, such as an electric generator (not shown). Although the particular coupling mechanism between the first magnets 61, the second magnets 62, and the crankshaft is not shown in FIG. 4, any coupling mechanism known in the art may be used.

In this embodiment, an energy-storage device (shown as a energy-storage device 46, a spring, in FIGS. 2A-2C) may be optional. Energy storage may not be needed (or relatively little energy storage may be needed in some embodiments) because the a first portion of the energy produced by the kinetic motion of the first magnet 61a as it moves through the power stroke step, in a direction D1a towards the second magnet 62a (with the assistance of the magnetic attraction force between the magnets 61a and 62a), may be transferred to the second magnet 62b to assist its motion through the separation stroke step, in a direction D2b away from the first magnet 61b (counter to the magnetic attraction force between the magnets 61b and 62b). At the same time, a second portion of the energy produced by the kinetic motion of the first magnet 61a as it moves through the power stroke step may be transferred to the first and second magnets 61c and 62c to assist their motion through the return step (to their initial positions), in directions D1c and D2c, respectively. At the same time, a third portion (the remainder) of the energy produced by the kinetic motion of the first magnet 61a as it moves through the power stroke step may be transferred to an external device, such as an electric generator (not shown).

In this embodiment, because all three portions of the energy produced by the power stroke step of the magnets 61a and 62a are simultaneously transferred to the magnets 61b and 62b (in the separation step), to the magnets 61c and 62c (in the return step), and to an external device, there may not be a need to include an integral energy-storage device in the motor 60. The external device, such as an electric generator, may include an energy-storage device, but inclusion of an energy-storage device in the motor 60 is optional. For example, an energy-storage device may not bee needed in embodiments where multiple magnet pairs 61 and 62 are coupled together and each pair cycles through the energy-generation process out-of-phase with the other pairs. In some embodiments, in order to completely avoid the need for an energy-storage device, it may be necessary to use enough pairs of the magnets 61 and 62 such that the moving parts of the motor 60 can store kinetic energy via their momentum, and some of this kinetic energy can be transferred to other components of the motor 60 as needed.

In this embodiment, the three magnet pairs of the motor 60 may continuously cycle between the three stages of energy-production as shown in FIGS. 2A-2C, with each pair of magnets 61 and 62 providing energy to the other two magnet sets and an external device during its power stroke, and each pair of magnets 61 and 62 receiving energy from one of the other two magnet sets during its separation stroke and return stroke.

For example, as shown in FIG. 4, first, the magnet pair 61a and 62a may undergo the power stroke process, and it may provide a first portion of energy for the separation stroke of the magnet pair 61b and 62b, a second portion of energy for the return stroke of the magnet pair 61c and 62c, and a third portion of energy to an external device. Next, the magnet pair 61c and 62c may undergo the power stroke process, and it may provide a first portion of energy for the separation stroke of the magnet pair 61a and 62a, a second portion of energy for the return stroke of the magnet pair 61b and 62b, and a third portion of energy to an external device. Finally, the magnet pair 61b and 61b may undergo the power stroke process, and it may provide a first portion of energy for the separation stroke of the magnet pair 61c and 62c, a second portion of energy for the return stroke of the magnet pair 61a and 62a, and a third portion of energy to an external device. Then, the three-step aforementioned cycle repeats indefinitely.

Using the aforementioned process, each of the three process steps of the magnet pairs of the motor 60 may provide first and second portions of energy to drive internal processes within the motor 60 and third portions of energy to an external device, such that the motor 60 may provide a continuous energy output to drive the external device. In some preferred embodiments, the motor 60 may operate without any external power source, using the spatially-uneven magnetic fields of the magnet pairs 61 and 62 in the aforementioned process to produce a continuous flow of energy to drive an external device.

Although FIG. 4 depicts only three magnet pairs 61 and 62, any number of magnet pairs 61 and 62 may be used in the motor 60, for example a multiple of three, such as six or nine, or even a non-multiple of three, such as ten (although in non-multiple of three embodiments it may be preferable to choose magnet sizes and strengths such that a substantially consistent level of energy is produced by the motor 60 over time). If a number of magnet pairs 61 and 62 is used that is greater than three, the energy produced during each power stroke preferably should be sufficient to drive other internal processes in the motor 60 and sufficient to produce energy to drive an external device. The exact configuration and number of magnet pairs 61 and 62 will depend on the desired size, shape, and desired net energy-yield and other performance characteristics of the motor 60.

FIG. 5 is a diagrammatic view of an exemplary linear permanent magnet motor, comprising six pairs of permanent magnets attached to a single pair of moveable heads, coupled to a crankshaft, each magnet pair performing the same step of the energy-generation process at any given time, illustrating a fifth embodiment of the invention.

Referring to FIG. 5, a permanent magnet motor 70 includes first magnets 71a through 71f, second magnets 72a through 72f, a first moveable head 73 (only a magnetized end of the head is shown), a second moveable head 74 (only a magnetized end of the head is shown), and a crankshaft (not shown). As shown in FIG. 5, an exemplary embodiment of permanent magnet motor 70 includes six pairs of permanent magnets, each pair going through its own energy-generation process at the same time. For the motion of a particular pair of a first magnet 71 and a second magnet 72, any embodiment can be used to govern the energy-generation process steps, for example, the first embodiment shown in FIGS. 1A-1C, the second embodiment shown in FIGS. 2A-2C, or any other embodiment according to the aforementioned discussion may be used.

The exemplary motor 70 shown in FIG. 5 is based on the motion of three magnet pairs, each one using a process generally according to the second embodiment shown in FIGS. 2A-2C (or according to the first embodiment shown in FIGS. 1A-1C). The motions of the first magnet 41 and the second magnet 42 in FIGS. 2A-2C can be broadly categorized into a power stroke (when the first magnet 41 moves towards the second magnet 42, traveling from initial horizontal position H1 to final horizontal position H2), a separation stroke (when the second magnet 42 moves away from the first magnet 41, traveling from initial vertical position V1 to final vertical position V2), and a return stroke (when the first magnet 41 and the second magnet 42 return to their respective initial positions H1 and V1). The motions of the magnets in FIGS. 1A-1C may also be categorized into a power stroke (e.g., power stroke curve 31), a separation stroke (e.g., separation stroke curve 32), and a return stroke.

In this embodiment, each of the six magnets 71a through 71f may be attached to a first moveable head 73, and each of the six magnets 72a through 72f may be attached to a second moveable head 74. The first moveable head 73 and the second moveable head 74 then may go through the aforementioned energy-generation process steps (such as those described in FIGS. 1A-1C or FIGS. 2A-2C), using the first head 73 as the first magnet 11 or 41, and using the second head 74 as the second magnet 12 or 42. In the embodiment depicted in FIG. 5, at any given time, all six magnet pairs may be in one of the three aforementioned energy-generation process steps: the power stroke, the separation stroke, and the return stroke. As shown in FIG. 5, all six first magnets 71a through 71f may move towards respective second magnets 72a through 72f during the power stroke, then all six magnet pairs may go through separation strokes and return strokes.

All six of these magnet pairs having a first magnet 71 and a second magnet 72 may be coupled, via the first moveable head 73 and the second moveable head 74, to a single crankshaft (not shown) through which energy may be transferred to an external device, such as an electric generator (not shown). Although the particular coupling mechanism between the first moveable head 73, the second moveable head 74, and the crankshaft is not shown in FIG. 4, any coupling mechanism known in the art may be used.

Although FIG. 5 depicts only six magnet pairs 71 and 72, any number of magnet pairs 71 and 72 may be used in the motor 70 and attached to the first moveable head 73 and the second moveable head 74, for example, two, five, ten, or any number that the user desired to include. The exact configuration and number of magnet pairs 71 and 72 will depend on the desired size, shape, and desired net energy-yield and other performance characteristics of the motor 70.

Although FIG. 5 depicts only one pair of heads 73 and 74, each incorporating six magnets 71 and 72, respectively, any number of heads 73 and 74 may be used, preferably coupled to a crankshaft in a manner as discussed related to the embodiment depicted in FIG. 4. For example, three pairs of heads 73 and 74 may be used, where three first heads 73a, 73b, and 73c are used in the manner of the first magnets 61a, 61b, and 61c as shown in FIG. 4, and three second heads 74a, 74b, and 74c are used in the manner of the second magnets 62a, 62b, and 62c as shown in FIG. 4. In this manner, the three pairs of heads 73 and 74 may continuously cycle between the three stages of energy-production as shown in FIGS. 2A-2C, as described above relating to FIG. 4, with each pair of heads 73 and 74 providing energy to the other two heads and an external device during its power stroke, and each pair of heads 73 and 74 receiving energy from one of the other two heads during its separation stroke and return stroke.

Any number of head pairs 73 and 74, incorporating a plurality of pairs of magnets 71 and 72, may be used in the motor 70, for example a multiple of three, such as six or nine, or even a non-multiple of three, such as ten (although in non-multiple of three embodiments it may be preferable to choose magnet sizes and strengths such that a substantially consistent level of energy is produced by the motor 70 over time). If a number of head pairs 73 and 74 is used that is greater than three, the energy produced during each power stroke preferably should be sufficient to drive other internal processes in the motor 70 and sufficient to produce energy to drive an external device. The exact configuration and number of head pairs 73 and 74 and included magnet pairs 71 and 72 will depend on the desired size, shape, and desired net energy-yield and other performance characteristics of the motor 70.

FIG. 6 is a diagrammatic view of an exemplary linear permanent magnet motor, comprising two moveable permanent magnets and three stationary permanent magnets, illustrating a sixth embodiment of the invention. Referring to FIG. 6, a permanent magnet motor 75 includes two moveable first magnets 76a and 76b having respective motion paths A and B, two stationary second magnets 77a and 77b, and a stationary shared magnet 78. Although FIGS. 1A through 5 only illustrate pairs of magnets, where one is a first magnet and another is a second magnet, embodiments with alternative configurations of magnets may be used that do not employ one-to-one pairs, as shown in FIG. 6.

According to the sixth embodiment shown in FIG. 6, the motor 75 includes two pairs of magnets 76 and 77, which may be used with a shared stationary magnet 78. Each pair of a first magnet 76 and a second magnet 77 may be used to perform the energy-generation steps that are described above related to FIGS. 1A-1B: a power stroke (e.g., power stroke curve 31), a separation stroke (e.g., separation stroke curve 32), and a return stroke. Each of the two magnet pairs 76a/77a and 76b/77b may perform the energy-generation steps simultaneously, in a staggered fashion (each pair performs the same steps with a time delay relative to the other pair), or in a sequential fashion (each pair alternates in performing the energy-generation steps). In this embodiment, the stationary shared magnet 78 may be used to assist each of the first magnets 76a and 76b in returning to their initial positions during their respective return stroke steps and also to generate additional energy during each of their respective motion paths A and B.

For example, as the first magnet 76a travels around the motion path A in the direction indicated by the arrows, the first magnet 76a approaches the second magnet 77a in a horizontal direction, performing a first power stroke step. Then, the first magnet 76a moves away from the second magnet 77a in a vertical direction, performing a first separation step. When the first magnet 76a is separated from the second magnet 77a, the magnetic attraction force between the first magnet 76a and the stationary shared magnet 78 pulls the first magnet 76a towards the stationary shared magnet 78 in a horizontal direction, performing a second power stroke during a single complete motion path A. Then, the first magnet 76a moves away from the stationary shared magnet 78 in a vertical direction, performing a second separation step. At this point, the first magnet 76a has traveled completely around motion path A and is ready to perform another energy-generation cycle. Although not shown in FIG. 6, the kinetic energy produced by the motion of the first magnets 76a and 76b may be stored in an energy-storage device, and a first portion of the energy may be used to perform the separation stroke, a second portion of the energy may be used to perform the return stroke, and a third portion of the energy may be transferred to an external device (not shown) such as an electric generator.

At the same time, or in a staggered or sequential fashion, the first magnet 76b may travel around the motion path B in the direction indicated by the arrows, performing two power stroke steps and two separation steps, using the magnetic attraction force between the first magnet 76b and the second magnet 77b and the stationary shared magnet 78 to generate energy during the two power strokes.

Although FIG. 6 illustrates an embodiment in which two moveable magnets 76 and three stationary magnets 77 and 78 are used, in alternate embodiments, any number of moveable magnets 76 and stationary magnets 77 and 78 may be used, in a simultaneous, sequential, or staggered fashion. The exact configuration of alternative embodiments of motor 75 will depend on the desired size, shape, and desired net energy-yield and other performance characteristics of motor 75.

FIGS. 7A and 7B are diagrammatic views of an exemplary linear permanent magnet motor, comprising three moveable permanent magnets, illustrating a seventh embodiment of the invention. Referring to FIG. 7A, a permanent magnet motor 80 includes a moveable first magnet 81 that is able to move along the X axis (as defined by the arrows in FIG. 7A) and two moveable second magnets 82a and 82b that are able to move along the Y axis (as defined by the arrows in FIG. 7A). According to the seventh embodiment shown in FIG. 7A, the motor 80 may perform some of the energy-generation steps that are described above related to FIGS. 1A-1B and FIGS. 2A-2C: a power stroke (e.g., power stroke curve 31) and a separation stroke (e.g., separation stroke curve 32). As shown in FIG. 7A, the magnets 81 and 82 move between four different location states, defined as first state S1, second state S2, third state S3, and fourth state S4.

As shown in FIG. 7A, the power strokes are provided by the first magnet 81, which moves alternately back and forth along the X axis (the first power stroke is from state S1 to state S2, then the second power stroke is from state S3 to state S4) as it is pulled by the magnetic attraction force between the first magnet 81 and alternately the second magnet 82a or the second magnet 82b. The separation strokes are provided by the motion of the second magnets 82a and 82b, which move alternately back and forth along the Y axis (the first separation stroke for magnet 82a is from state S2 to state S3, then the second separation stroke for magnet 82b is from state S4 to state S1) as they are pulled away from the first magnet 81, counter to the magnetic attraction force between the second magnets 82 and the first magnet 81. Having the power strokes provided by a first magnet 81, moving along one axis, and having the separation strokes provided by a second magnet 82, moving along a second perpendicular axis, are illustrated above in FIGS. 2A-2C and described in the accompanying text. As in FIGS. 2A-2C, each of the first magnet 81 and the second magnets 82 are preferably oriented such that their pole axes are substantially parallel.

Referring to FIG. 7B, a permanent magnet motor 80 includes a moveable first magnet 81 that is able to move along the X axis (as defined by the arrows in FIG. 7B) two moveable second magnets 82a and 82b that are able to move along the Y axis (as defined by the arrows in FIG. 7B), a first magnet motion assembly 83 that may rotate in a direction R1, a second magnet motion assembly 84 that may rotate in a direction R2, energy-storage devices 85, an energy transfer motion assembly 86 that may rotate in a direction R3, an external device motion assembly 87 that may rotate in a direction R4, and an external device 88, which may be a flywheel as depicted in FIG. 7B or any other external device, such as an electric generator. In FIG. 7B, the motion of the first magnet 81 and the second magnets 82a and 82b follows the paths shown in FIG. 7A and discussed in the accompanying text. In addition, FIG. 7B shows a preferred configuration for transferring the kinetic energy produced by the X-axis motion of the first magnet 81 to drive the Y-axis motion of the second magnets 82a and 82b as well as an external device 88.

In this embodiment, the first magnet 81 is pulled, in a first power stroke, by attractive magnetic forces along the X-axis towards the second magnet 82a. The kinetic energy produced by the motion of the first magnet 81 is transferred to the other system components via the first magnet motion assembly 83, which is rotated in a direction R1 by an included coupling mechanism. A first portion of the kinetic energy produced by the motion of the first magnet 81 is transferred to the second magnets 82a and 82b via the energy transfer motion assembly 86 and then the second magnet motion assembly 84, which is coupled to the first magnet motion assembly 83 preferably via gears as shown in FIG. 7B. Part of this first portion of energy may be stored in energy-storage devices 85, shown as springs, which may assist the second magnets 82a and 82b to alternately perform separation strokes, moving away from the first magnet 81, counter to the magnetic attraction forces.

Once the first magnet 81 completes its travel in the X direction towards the second magnet 82a (the first power stroke), the second magnet 82a is pulled away from the first magnet 81 in the Y direction, using a combination of the first portion of energy from the first magnet 81 and the energy-storage springs 85a. At the same time that the second magnet 82a is pulled in the Y direction, the second magnet 82b is pushed in the opposite direction (negative Y direction), such that magnetic attraction forces will pull the first magnet 81 back (the second power stroke) towards the second magnet 82b (in the negative X direction), using a combination of the first portion of energy from the first magnet 81 and the energy-storage springs 85b.

A second portion of the kinetic energy produced by the motion of the first magnet 81 may be transferred to an external device 88, such as the flywheel depicted in FIG. 7B, via the energy transfer motion assembly 86 and then the external device motion assembly 87 preferably via gears as shown in FIG. 7B. Once the first magnet 81 completes the second power stroke, returning to its initial position at the far left end of its range of travel (as shown in FIG. 7B), the motor 80 is ready to perform another energy-generation cycle.

Although FIGS. 7A and 7B illustrate an embodiment which includes one first moveable magnet 81 and two second moveable magnets 82, in alternate embodiments, any number of first moveable magnets 81 and second moveable magnets 82 may be used. The exact configuration of alternative embodiments of motor 80 will depend on the desired size, shape, and desired net energy-yield and other performance characteristics of motor 80.

FIG. 8 is a diagrammatic views of an exemplary linear permanent magnet motor, comprising four moveable permanent magnets, illustrating an eighth embodiment of the invention. Referring to FIG. 8, a permanent magnet motor 90 includes two moveable first magnets 91a and 91b that are able to move along the X axis (as defined by the arrows in FIG. 8) and two moveable second magnets 92a and 92b that are able to move along the Y axis (as defined by the arrows in FIG. 8). According to the eighth embodiment shown in FIG. 8, the motor 90 may perform some of the energy-generation steps that are described above related to FIGS. 1A-1B and FIGS. 2A-2C: a power stroke (e.g., power stroke curve 31) and a separation stroke (e.g., separation stroke curve 32). As shown in FIG. 8, the magnets 91 and 92 move between four different location states, defined as first state S1′, second state S2′, third state S3′, and fourth state S4′.

As shown in FIG. 8, the power strokes are provided by the first magnets 91a and 91b, which move alternately back and forth along the X axis (the first power stroke is from state S1′ to state S2′, then the second power stroke is from state S3′ to state S4′) as they are pulled by the magnetic attraction force between the first magnet 91a and 91b and alternately the second magnet 92a or the second magnet 92b. The separation strokes are provided by the motion of the second magnets 92a and 92b, which move alternately back and forth along the Y axis (the first separation stroke is from state S2′ to state S3′, then the second separation stroke is from state S4′ to state S1′) as they are alternately pulled away from the first magnets 91a and 92a, counter to the magnetic attraction force between the second magnets 92 and the first magnets 91.

In this embodiment, the first magnet 91a is alternately paired with either the second magnet 92a or the second magnet 92b. During the first power stroke, the first magnet 91a is paired with the second magnet 92a, and during the second power stroke, the first magnet 91a is paired with the second magnet 92b. The first magnet 91b is also alternatively paired with either the second magnet 92a or the second magnet 92b, but in the opposite order as the first magnet 91a. For example, during the first power stroke, the first magnet 91b is paired with the second magnet 92b, and during the second power stroke, the first magnet 91b is paired with the second magnet 92a.

Having the power strokes provided by a first magnet 91, moving along one axis, and having the separation strokes provided by a second magnet 92, moving along a second perpendicular axis, are illustrated above in FIGS. 2A-2C and described in the accompanying text. As in FIGS. 2A-2C, each of the first magnets 91 and the second magnets 92 are preferably oriented such that their pole axes are substantially parallel.

Although FIG. 8 illustrates an embodiment which includes two first moveable magnets 91 and two second moveable magnets 92, in alternate embodiments, any number of first moveable magnets 91 and second moveable magnets 92 may be used. The exact configuration of alternative embodiments of motor 90 will depend on the desired size, shape, and desired net energy-yield and other performance characteristics of motor 90.

Although FIGS. 1A through 8 illustrate magnets moving in two dimensions (a single plane), embodiments with alternative configurations of magnets may be used that move in three dimensions (not shown). For example, in the embodiment of motor 60 depicted in FIG. 4, each of the pairs of magnets 61 and 62 may move in different planes relative to each other, for example, magnets 61a and 62a may move in an X-Y plane, magnets 61b and 62b may move in an Y-Z plane, and magnets 61c and 62c may move in an X-Z plane. Also, for example, in the embodiment of motor 40 depicted in FIGS. 2A-2C, the motion of first magnet 41 as it moves from initial position H1 to final position H2 may be a non-linear motion that takes place in an X-Y plane, while the motion of second magnet 42 as it moves from initial position V1 to final position V2 may be a non-linear motion that takes place in an X-Z plane relative to the aforementioned X-Y plane. The combination of motions of the first magnet 41 and the second magnet 42 would thereby be non-planar, taking place in three-dimensional space.

While the invention has been described with reference to preferred embodiments or preferred methods, it is understood that the words which have been used herein are words of description and illustration, rather than words of limitation. Although the invention has been described herein with reference to particular structure, methods, and embodiments, the invention is not intended to be limited to the particulars disclosed herein, as the invention extends to all structures, methods and uses that are within the scope of the appended claims. Further, several advantages have been described that flow from the structure and methods; the present invention is not limited to structure and methods that encompass any or all of these advantages. Those skilled in the relevant art, having the benefit of the teachings of this specification, may effect numerous modifications to the invention as described herein, and changes may be made without departing from the scope and spirit of the invention as defined by the appended claims.

### APPENDICES

Appendix A-1 is a table and graph showing the raw data collected from three trials measuring the attractive magnetic force (in pounds) acting on the first magnet 11 (according to the first embodiment depicted in FIGS. 1A-1C) at 1/32″ intervals along a horizontal path taken by the first magnet 11, moving from the intermediate position P2 to the initial position P1. The measurements were taken as the first magnet 11 moved in a direction opposite that of the direction D1 depicted in FIG. 1A.

To create the graph, the average force values for the three trials were used, and the values were adjusted to remove the friction drag force experienced by the first magnet 11 during the trials. For these trials, the magnets 11 and 12 used were made of neodymium (NdFeB), grade N38, with a nickel coating, and they each defined a cubic shape, measuring ¾″ in each dimension. Each of the magnets 11 and 12 weighed 1.83 ounces. A pull force of 43.40 pounds was used. The surface field was 5,860 gauss.

Appendix A-2 is a table and graph showing the raw data collected from three trials measuring the attractive magnetic force (in pounds) acting on the first magnet 11 (according to the first embodiment depicted in FIGS. 1A-1C) at 1/32″ intervals along a vertical path taken by the first magnet 11, moving from the intermediate position P2 to the final position P3. The measurements were taken as the first magnet 11 moved in the direction D2 depicted in FIG. 1B.

To create the graph, the average force values for the three trials were used, and the values were adjusted to remove the friction drag force experienced by the first magnet 11 during the trials. For these trials, the magnets 11 and 12 used were made of neodymium (NdFeB), grade N38, with a nickel coating, and they each defined a cubic shape, measuring ¾″ in each dimension. Each of the magnets 11 and 12 weighed 1.83 ounces. A pull force of 43.40 pounds was used. The surface field was 5,860 gauss.

Appendix A-3 is a table and graphs showing the raw data collected from five sets of three trials each, measuring the attractive magnetic force (in pounds) acting on the first magnet 11 (according to the embodiment depicted in FIGS. 1A-1C) at 1/32″ intervals along a horizontal path taken by the first magnet 11, moving from the intermediate position P2 to the initial position P1, using five different values of the gap spacing 13. Measurements were taken as the first magnet 11 moved in a direction opposite the direction D1 depicted in FIG. 1A.

To create the graph, the average force values for the three trials at each value of gap spacing 13 were used (average values are shown), and the values were adjusted to remove the friction drag force experienced by the first magnet 11. For these trials, the magnets 11 and 12 used were made of neodymium (NdFeB), grade N38, with a nickel coating, and they each defined a cubic shape, measuring ¾″ in each dimension. Each of the magnets 11 and 12 weighed 1.83 ounces. A pull force of 43.40 pounds was used. The surface field was 5,860 gauss.

Appendix A-4 is a table and graphs showing the raw data collected from five sets of three trials each, measuring the attractive magnetic force (in pounds) acting on the first magnet 11 (according to the first embodiment depicted in FIGS. 1A-1C) at 1/32″ intervals along a vertical path taken by the first magnet 11, moving from the intermediate position P2 to the final position P3, using five different values of the stagger spacing 14. The measurements were taken as the first magnet 11 moved in the direction D2 depicted in FIG. 1B.

To create the graph, the average force values for the three trials at each value of stagger spacing 14 were used (average values are shown), and the values were adjusted to remove the friction drag force experienced by the first magnet 11. The magnets 11 and 12 used were made of neodymium (NdFeB), grade N38, with a nickel coating, and they each defined a cubic shape, measuring ¾″ in each dimension. Each of the magnets 11 and 12 weighed 1.83 ounces. A pull force of 43.40 pounds was used. The surface field was 5,860 gauss.

Appendix A-5 is a table and graph showing the raw data collected from 25 trials, measuring the total work (energy) expended to move the first magnet 11 (according to the first embodiment depicted in FIGS. 1A-1C) along a horizontal path taken by the first magnet 11, moving from the intermediate position P2 to the initial position P1 (opposite the direction D1), using five different values of the gap spacing 13, and along a vertical path taken by the first magnet 11, moving from the intermediate position P2 to the final position P3 (in the direction D2), using five different values of the stagger spacing 14. The values were adjusted to remove the friction drag force experienced by the first magnet 11. The magnets 11 and 12 used were made of neodymium (NdFeB), grade N38, with a nickel coating, and they each defined a cubic shape, measuring ¾″ in each dimension. The magnets 11 and 12 weighed 1.83 ounces. A pull force of 43.40 pounds was used. The surface field was 5,860 gauss.

For each combination of a gap spacing 13 and a stagger spacing 14, the top number is the work expended to move the first magnet 11 from position P2 to P3 using the stagger spacing 14 value at the top of the respective column, the middle number is the work expended to move the first magnet 11 from position P2 to P1 using the gap spacing 13 value at the far left of the respective row, and the bottom number is the difference between the first two numbers that represents the net yield of energy that would be produced if the respective gap spacing 13 and stagger spacing 14 were used to move the first magnet 11 from position P1 to position P2 and then to position P3.

What is claimed:

1. A method of generating energy, comprising the steps of:
providing a first permanent magnet in a first initial location and a second permanent magnet in a second initial location, where the first and second magnets are positioned such that their poles have approximately the same relative orientation;
moving the first and second magnets towards each other relatively by moving either or both the first magnet and the second magnet substantially along a first axis that is approximately perpendicular to the orientation of their poles;
separating the first and second magnets by moving either or both the first magnet and the second magnet substantially along a second axis that is approximately parallel to the orientation of their poles; and
returning the first and second magnets to their respective first and second initial locations.

2. The method of claim 1, wherein the moving step is assisted by attractive magnetic forces acting between the first magnet and the second magnet.

3. The method of claim 1, wherein no external energy source is used.

4. The method of claim 1, wherein a gap is maintained between the first and second magnets such that they do not contact each other.

5. The method of claim 1, wherein a stagger distance is maintained between the first and second magnets such that the orientation of their poles is not linearly coincident.

6. The method of claim 1, further comprising the step of providing a magnetic shield around a portion of either or both the first magnet and the second magnet.

7. The method of claim 1, wherein the first and second magnets define first and second respective lengths, widths, and heights, the first and second heights being approximately parallel to the second linear axis and being less than the respective first and second lengths and widths.

8. The method of claim 1, further comprising the step of storing a part of the energy produced during the moving step.

9. The method of claim 8, further comprising the steps of:
providing a first pulley or gear; and
coupling the first pulley or gear to either the first or second magnet.

10. The method of claim 9, wherein the first pulley or gear is non-circular and includes a variable-leverage arm profile.

11. The method of claim 10, wherein the variable-leverage arm profile of the first pulley or gear is correlated to the shape of a curve of the magnetic force experienced by either the first or second magnet during the moving step.

12. The method of claim 9, further comprising the steps of:
providing a second pulley or gear; and
coupling the first and second pulleys or gears to the respective first and second magnets.

13. The method of claim 12, wherein the first and second pulleys or gears are non-circular, each pulley or gear including a variable-leverage arm profile.

14. The method of claim 8, wherein a first portion of the stored energy is used during the separating step.

15. The method of claim 14, wherein a second portion of the stored energy is used during the returning step.

16. The method of claim 15, further comprising the step of transferring a third portion of the stored energy to an external device.

17. A permanent magnet motor, comprising:
first and second permanent magnets;
a non-circular pulley or gear including a variable-leverage arm profile, coupled to the first magnet; and
an energy-storage device, coupled to the non-circular pulley or gear.
wherein the freedom of motion of the first and second magnets is constrained such that the magnets are only capable of moving towards each other or separating by moving either or both the first magnet and the second magnet substantially along a first axis or a second axis;
wherein the first axis is approximately perpendicular to the orientation of their poles; and
wherein the second axis is approximately parallel to the orientation of their poles.

18. The permanent magnet motor of claim 17, wherein the first and second magnets are positioned such that their poles have approximately the same relative orientation.

19. The permanent magnet motor of claim 17, wherein the first and second magnets are positioned in first and second initial locations such that attractive magnetic forces are acting between the first magnet and the second magnet.

20. The permanent magnet motor of claim 17, wherein no external energy source is used.

21. The permanent magnet motor of claim 17, further comprising a second pulley or gear, coupled to the second magnet.

22. The permanent magnet motor of claim 17, further comprising a magnetic shield around a portion of either or both the first magnet and the second magnet.
